(19) United States
(12) Patent Application Publication
(10) Pub. No.: US 2007/0246430 A1
(43) Pub. Date: Oct. 25, 2007

(54) Fluid Magnetic Treatment Unit having Moving or Stationary Magnets

(76) Inventor: Yiu Chau Chau, Richmond Hill (CA)

Correspondence Address: DEWITT ROSS & STEVENS S.C., 8000 EXCELSIOR DR, SUITE 401, MADISON, WI, 53717-1914, US

(21) Appl. No.: 11/379,487

(22) Filed: Apr. 20, 2006

(51) Int. Cl. C02F 1/48

(52) U.S. Cl. 210/695; 210/222; 96/1; 95/28

(57) ABSTRACT

A fluid magnetic treatment unit and treatment method are disclosed. Fluid flows through at least one annular magnet with direction of flow always perpendicular to the line of magnetic force generated by the annular magnet and closely along the surfaces of the annular magnet. The fluid flows in series, in parallel or any combination of in series and in parallel. The annular magnet may be a ring magnet, a disc magnet or a ring-shaped electromagnet. In order to maximize the magnetic treatment effect, the annular magnet is driven to spin in a direction preferable opposite to the direction of fluid flow.

### FIELD OF THE INVENTION

The present invention relates to an apparatus and a method for magnetically treating fluid with direction of flow always perpendicular to the line of magnetic force generated by the annular magnet(s) and closely along the surfaces of the annular magnet(s), said fluid flows in series, in parallel or any combination of in series and in parallel, more particular to maximize the magnetic treatment effect by optionally spinning the annular magnet(s) in a direction preferably opposite to the direction of fluid flow.

### BACKGROUND OF THE INVENTION

Prior to this invention, it has been known that fluids passing through a magnetic treatment unit will activate the fluid molecules. The effectiveness of activation of fluid molecules depends on the way fluid passing through the magnetic treatment unit.

U.S. Pat. No. 5,882,514 discloses an apparatus for magnetically treating fluid comprising a stack of ring magnets or disc magnets with fluid passing through spirally through the apparatus internally or externally, respectively. The method will extend the duration of fluid passing through the apparatus with the direction of fluid flow at an angle of approximately 45 degrees to the line of magnetic force but never perpendicular to the line of magnetic force. U.S. Pat. No. 6,752,923 discloses a similar apparatus comprising a stack of ring magnets with fluid passing through the apparatus spirally through the apparatus internally. Same as the U.S. Pat. No. 5,882,514, the duration of fluid passing through the apparatus is extended with the direction of fluid flow at an angle of approximately 45 degrees to the line of magnetic force but never perpendicular to the line of magnetic force. U.S. Pat. No. 4,935,133 discloses an apparatus for magnetically treating fluid comprising a stack of ring magnets with fluid passing through radically through the apparatus from inside of the ring magnets. The method ensures that the direction of fluid flow is always perpendicular to the line of magnetic force but without any extension of duration. U.S. Pat. No. 5,866,010 discloses a similar apparatus for magnetically treating fluid comprising a stack of ring magnets with fluid passing through radically through the stack of ring magnets one by one, in series. The method ensures that the direction of fluid flow is always perpendicular to the line of magnetic force with significant extension of duration. Notwithstanding, there is still room for improvement.

It is therefore advantageous to design a fluid magnetic treatment unit to devoid the shortcomings associated with prior art magnetic fluid treatment unit and to improve upon them.

### SUMMARY OF THE INVENTION

The present invention relates to an apparatus and a method for magnetically treating fluid with direction of flow always perpendicular to the line of magnetic force generated by the annular magnet(s) and flows closely along the surfaces of the annular magnet(s), said fluid flows in series, in parallel or any combination of in series and in parallel. In order to maximize the magnetic treatment effect, the annular magnet(s) is driven to spin in a direction preferably opposite to the direction of fluid flow.

The present invention discloses an apparatus for magnetically treating fluid comprising a stack of annular magnets. The annular magnet may be a ring magnet, a disc magnet or a ring-shaped electromagnet. For a ring magnet, there are four (4) annular surfaces—upper, lower, inner and outer annular surface. The apparatus includes a housing with an inlet, an outlet and at least one ring magnet(s). Fluid flows into the housing through the inlet, then flows annularly along the annular surfaces of each ring magnet and eventually exit the housing through the outlet. Fluid flows annularly along each annular surface of each ring magnet in parallel, said fluid flows in series or in any combination of in parallel and in series. For example, for the mean diameter of the ring magnet is 2 inches with thickness of 0.25 inches, if fluid flows perpendicular through the ring magnet, the effective distance is 0.25 inches only and the direction of fluid flow is not always perpendicular to all the lines of magnetic force generated by the ring magnet. If fluid flows in series annularly along each annular surface of the ring magnet, then the effective distance is 25.13 inches (4×2×3.1416) which is 100 times more than the above and the direction of fluid flow is always perpendicular to all the lines of magnetic force generated by the ring magnet. For the distribution of strength of magnetic line of force, the location closer to the poles of a ring magnet, the stronger the strength of magnetic line of force. The strength of magnetic line of force is inversely proportional to the square of distance. Hence, the strength of magnetic line of force is stronger on the upper and lower surfaces of a ring magnet than that on the outer and inner surfaces of the same ring magnet especially when a stack of ring magnets with opposite poles of adjacent ring magnets are positioned facing each other. Therefore, it is more preferable to have fluid flows annularly along only the upper and/or lower annular surfaces of each ring magnets, said fluid flows in series, in parallel or in any combination of in series or in parallel.

In addition, if the fluid flowing through the annular channel with one pole of the ring magnet on one side and the other side is only a partition and the effectiveness of activating the fluid molecules is 1, then the same fluid flowing through the same annular channel with one pole of the ring magnet on one side of the annular channel and the other pole of another ring magnet on the other side of the same annular channel and the effectiveness of activating the fluid molecules will be 4-fold. Hence, it is more preferable to have fluid flows annularly with the poles of ring magnets on both sides of the annular channel.

It is understood that we can also have a ring magnet with poles on the outer and inner annular surfaces instead of upper and lower annular surfaces. Although it is more advantageous to have fluid passing through both poles of magnets, there is a difference on effectiveness of activation of fluid molecules between fluid passing through south pole and fluid passing through north pole. Magnetic researches have revealed that there is significant difference between north and south poles energy. North pole energy has a counter clockwise spin and it gives energy. South pole energy has a clockwise spin and it withdraws energy. Therefore, it is necessary to have three different ways of fluid passing through the ring magnet namely fluid passing through both poles, fluid passing through south pole and fluid passing through north pole. Furthermore, the stack of ring magnets can be arranged in such a way that it is driven to spin in a direction preferably opposite to the direction of fluid flow. For example, if fluid flows with a speed of 1 revolution per second and the stack of ring magnets is driven to spin in an opposite direction of 100 revolutions per second, then the effectiveness is improved by 100 times.

With modification, a stack of ring-shaped electromagnets can replace the stack of ring magnets in the above apparatus and the result is the same.

With another modification, a stack of disc magnets can replace the stack of ring magnets in the above apparatus and the result is the same as above except there are only three (3) annular surfaces (upper, lower and outer annular surface) instead of four (4) annular surfaces (upper, lower, inner and outer annular surface).

### BRIEF DESCRIPTION OF THE DRAWINGS

Advantages and features of the invention will become more apparent with reference to the following description of the presently preferred embodiment thereof in connection with accompanying drawings, wherein like references have been applied to like elements, in which:

FIG. 1 is a schematic diagram showing the treatment effect on the relationship between direction of fluid flow and direction of magnetic line of force generated by a magnet;

FIG. 2 is a schematic diagram showing the distribution of strength of magnetic line of force of a magnet;

FIG. 3 is a schematic diagram showing fluid flows along four annular surfaces of a ring magnet in clockwise direction and the ring magnet being driven to spin in anti-clockwise direction;

FIG. 3A is a cross-sectional view of a ring magnet with covers;

FIG. 4 is a schematic diagram showing fluid flows along annular surfaces of a stack of ring magnets with same pole facing each other in clockwise direction and the stack of ring magnets being driven to spin in anti-clockwise direction;

FIG. 5 is a schematic diagram showing fluid flows along annular surfaces of a stack of ring magnets with opposite pole facing each other in clockwise direction and the stack of ring magnet being driven to spin in anti-clockwise direction;

FIG. 6 is a schematic diagram showing fluid flows along annular surfaces of a disc magnet in clockwise direction and the disc magnet being driven to spin in anti-clockwise direction;

FIG. 6A is a cross-sectional view of a disc magnet with covers;

FIG. 7 is a schematic diagram showing fluid flows along annular surfaces of a stack of disc magnets with same pole facing each other in clockwise direction and the stack of disc magnets being driven to spin in anti-clockwise direction;

FIG. 8 is a schematic diagram showing fluid flows along annular surfaces of a stack of disc magnets with opposite pole facing each other in clockwise direction and the stack of disc magnets being driven to spin in anti-clockwise direction;

FIG. 9 is a schematic diagram showing fluid flows along annular surfaces of a ring-shaped electromagnet in clockwise direction and the ring-shaped electromagnet being driven to spin in anti-clockwise direction;

FIG. 10 is an exploded view of a preferred embodiment of a ring-shaped electromagnet;

FIG. 11 is an assembly of a stack of ring magnets with an insert provided therebetween;

FIG. 12 is an exploded view of a preferred embodiment of a stack of ring magnets with an insert provided therebetween;

FIG. 13 is a cross-sectional view of a stack of ring magnets with an insert provided therebetween and a separate housing to allow fluid passing in series through along three annular surfaces of each ring magnet;

FIG. 13A is a cross-sectional view of a stack of disc magnets with an insert provided therebetween and a separate housing to allow fluid passing in series through along three annular surfaces of each ring magnet;

FIG. 14 is an exploded view of a preferred embodiment of a stack of ring magnets with an insert provided therebetween and a separate housing to allow fluid passing in series through three annular surfaces of each ring magnet;

FIG. 15 is an exploded view of a preferred embodiment of a separate housing to allow fluid passing in series through the upper, outer and lower annular surfaces of each ring magnet without showing the stack of ring magnets with an insert provided therebetween;

FIG. 16 is an exploded view of a preferred embodiment of a separate housing to allow fluid passing in series through the upper and lower annular surfaces of each ring magnet without showing the stack of ring magnets with an insert provided therebetween;

FIG. 17 is an exploded view of a preferred embodiment of a separate housing to allow fluid passing in parallel through the upper and lower annular surfaces of all ring magnets without showing the stack of ring magnets with an insert provided therebetween;

FIG. 18 is an exploded view of a preferred embodiment of a separate housing to allow fluid passing in parallel through the upper, outer and lower annular surfaces of all ring magnets without showing the stack of ring magnets with an insert provided therebetween;

FIG. 19 is a cross-sectional view of a stack of ring magnets and a separate housing to allow fluid passing in series through four annular surfaces of each ring magnet;

FIG. 20 is an exploded view of a preferred embodiment of a separate housing to allow fluid passing in series through four annular surfaces of each ring magnet;

FIG. 21 is an exploded view of a preferred embodiment of a separate housing to allow fluid passing in series through four annular surfaces of ring magnet without showing the stack of ring magnets;

FIG. 22 is a cross-sectional view of a stack of ring magnets with partitions in between and a housing to allow fluid passing in series through the upper and lower annular surfaces of each ring magnet;

FIG. 23 is an exploded view of a preferred embodiment of a stack of ring magnets with partitions in between and a housing with partitions to allow fluid passing in series through the upper and lower annular surfaces of each ring magnet;

FIG. 24 is an exploded view of a preferred embodiment of a housing with partitions to allow fluid passing in series through the upper and lower annular surfaces of each ring magnet;

FIG. 25 is an exploded view of a preferred embodiment of a housing with partitions to allow fluid passing in parallel through the upper and lower annular surfaces of all ring magnets;

FIG. 26 is an exploded view of a preferred embodiment of a housing with partitions to allow fluid passing in parallel through the upper, outer, lower and inner annular surfaces of all ring magnets;

FIG. 27 is a cross-sectional view of a stack of disc magnets with partitions in between and a housing to allow fluid passing in series through the upper and lower annular surfaces of each disc magnet;

FIG. 28 is an exploded view of a preferred embodiment of a stack of disc magnets with partitions in between and a separate housing to allow fluid passing in series through the upper and lower annular surfaces of each disc magnet;

FIG. 29 is an exploded view of a preferred embodiment of a separate housing to allow fluid passing in series through the upper and lower annular surfaces of each disc magnet without showing the stack of disc magnets with an insert provided therebetween;

FIG. 30 is an exploded view of a preferred embodiment of a separate housing to allow fluid passing in parallel through the upper and lower annular surfaces of all disc magnets without showing the stack of disc magnets with an insert provided therebetween;

FIG. 31 is an exploded view of a preferred embodiment of a separate housing to allow fluid passing in parallel through the upper, outer, and lower annular surfaces of all disc magnets without showing the stack of disc magnets with an insert provided therebetween;

FIG. 32 is an exploded view of a preferred embodiment of a separate housing to allow fluid passing in series through the upper, outer, and lower annular surfaces of each disc magnets without showing the stack of disc magnets with an insert provided therebetween; and Referring to FIG. 33, an exploded view of a preferred embodiment of a partition on top of a ring magnet with fluid flows through two annular passes along the upper annular surface of that ring magnet.

### DETAILED DESCRIPTION OF THE PREFERRED EMBODIMENTS

A fluid magnetic treatment unit for magnetically treating fluid, which fluid flows through the unit, is disclosed herein. The unit comprises a housing with an inlet, an outlet and at least one annular magnet. Fluid flows into the housing through the inlet, then continues to flow annularly along the annular surfaces of each annular magnet and eventually exits the housing through the outlet. Fluid flows annularly along each annular surface of each annular magnet, said fluid flows in series, in parallel or in any combination of in series and in parallel. In order to maximize the magnetic treatment effect, the annular magnet is driven to spin in a direction preferably opposite to the direction of fluid flow. In this regard, the annular magnet is positioned within the housing without touching the housing of the fluid passages and is, therefore, free to spin. The annular magnet can be caused to rotatably spin directly or indirectly by a rotational means, such as by coupling with a motor or a turbine driven by the fluid flow or any other commonly acceptable methods.

A method for fluid magnetic treatment employing the treatment unit of the present invention is also disclosed.

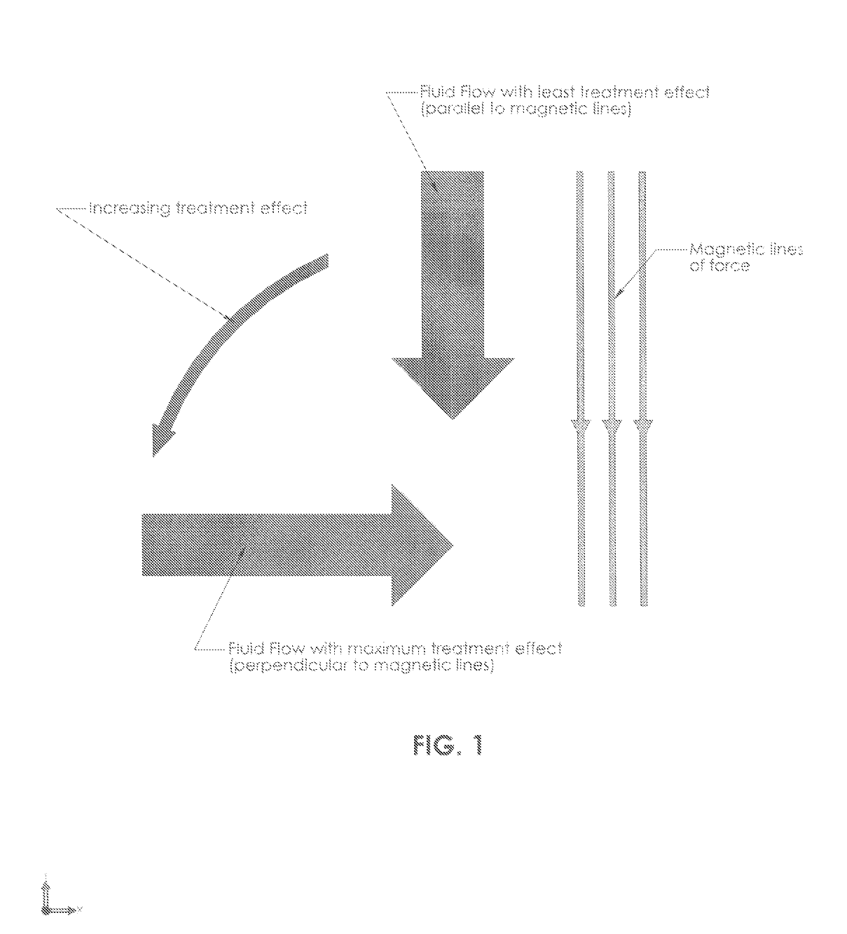

Referring to FIG. 1, a schematic diagram showing the treatment effect on the relationship between direction of fluid flows and direction of magnetic line of force generated by a magnet. When the fluid flow is parallel to the magnetic lines of force, the treatment effect is the least and increasing to maximum when the fluid flow is perpendicular to the magnetic lines of force.

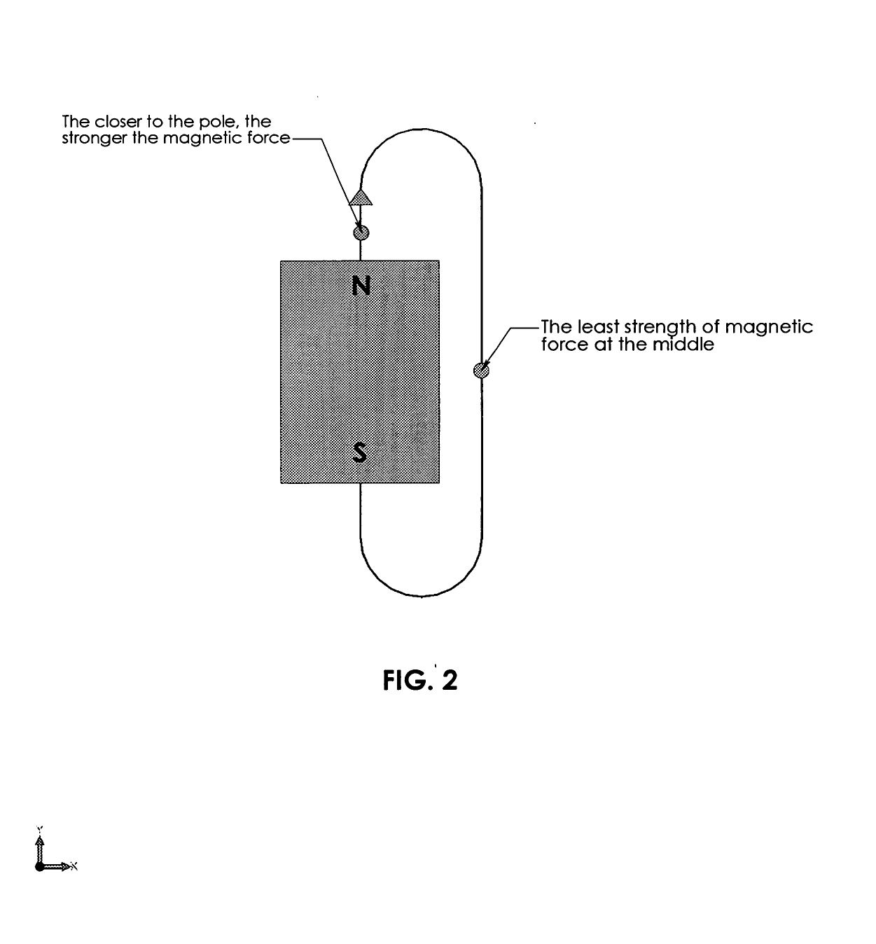

Referring to FIG. 2, a schematic diagram showing the distribution of strength of magnetic line of force of a magnet. The closer to either magnetic poles, the stronger the strength of magnetic line of force. Eventually, the strength of magnetic force will become the least at the middle.

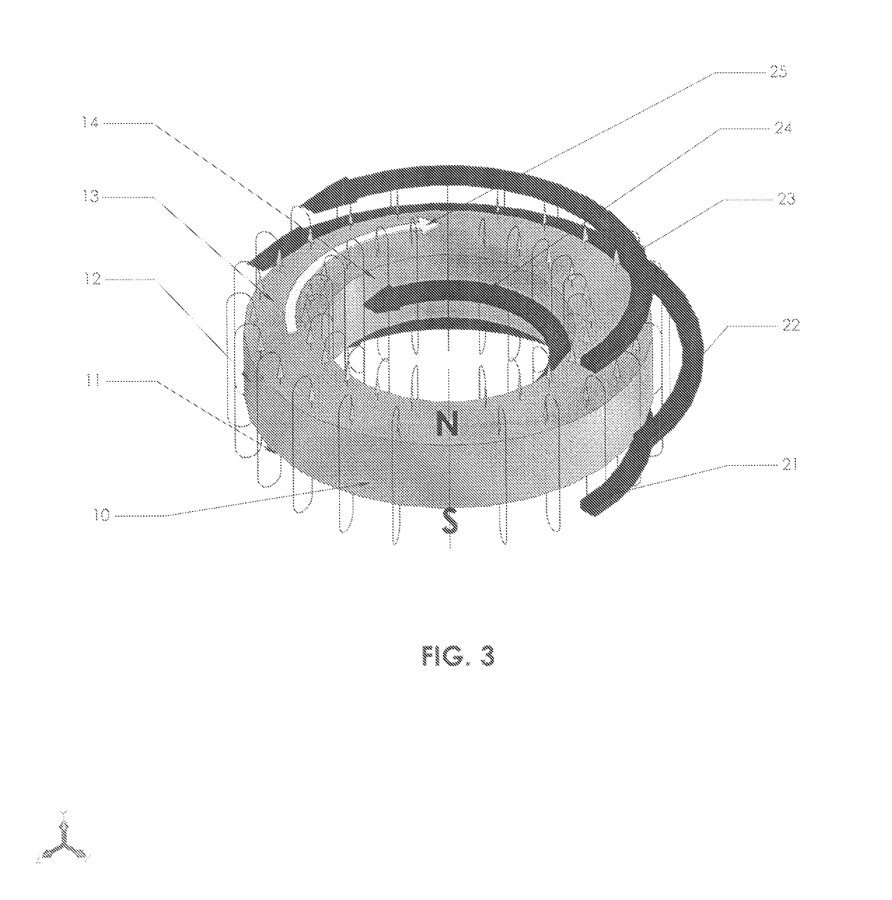

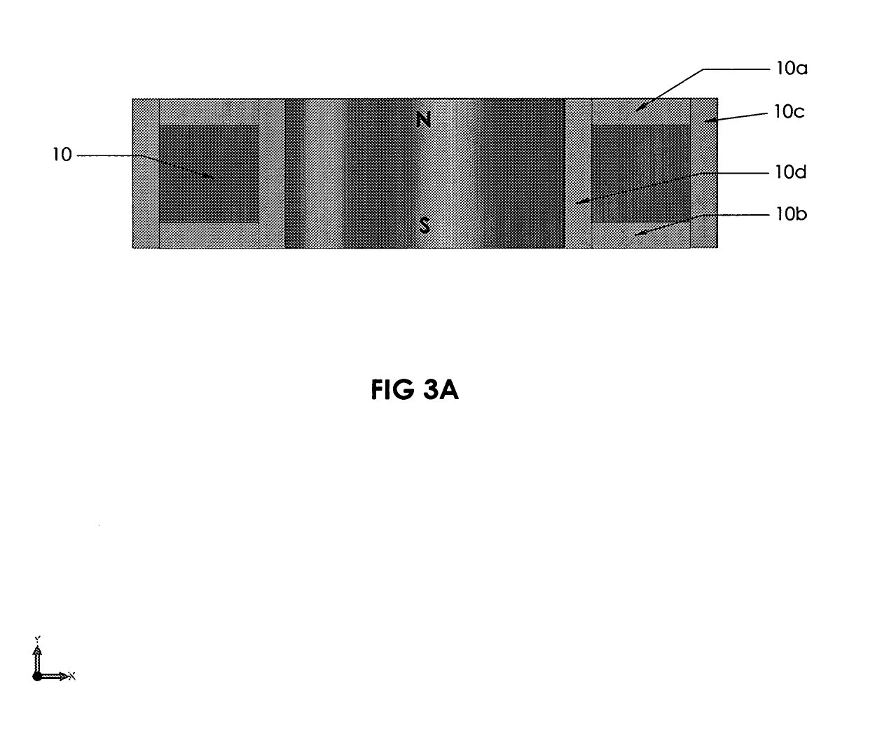

Referring to FIG. 3, a schematic diagram showing fluid flows along four annular surfaces of a ring magnet in clockwise direction and the ring magnet being driven to spin in anti-clockwise direction. Ring magnet 10 has four annular surfaces, namely lower annular surface 11, outer annular surface 12, upper annular surface 13 and inner annular surface 14. Arrow 21, arrow 22, arrow 23 and arrow 24 showing fluid flows along lower annular surface 11, outer annular surface 12, upper annular surface 13 and inner annular surface 14, respectively, with ring magnet 10 being driven to spin in a direction opposite to the direction to fluid flow as shown by arrow 25. It is understood that the annular ring magnet used in the present invention could have poles on outer and inner annular surfaces, instead of upper and lower annular surfaces. Referring to FIG. 3A, a cross-sectional view of a ring magnet with covers. Some magnet materials are more powerful (such as neodymium iron boron (Nd—Fe—B) which is ten times more powerful) than common magnet materials (such as ferrite) but get rusting easily. Therefore, protection is necessary. As shown in FIG. 3A, the best way to protect the magnet without sacrificing any magnetic power is to put covers 10a and 10b using magnetic material such as ferrite on the poles of the ring magnet 10 and covers 10c and 10d using non-magnetic material such as plastic on the other two annular surfaces of the ring magnet 10.

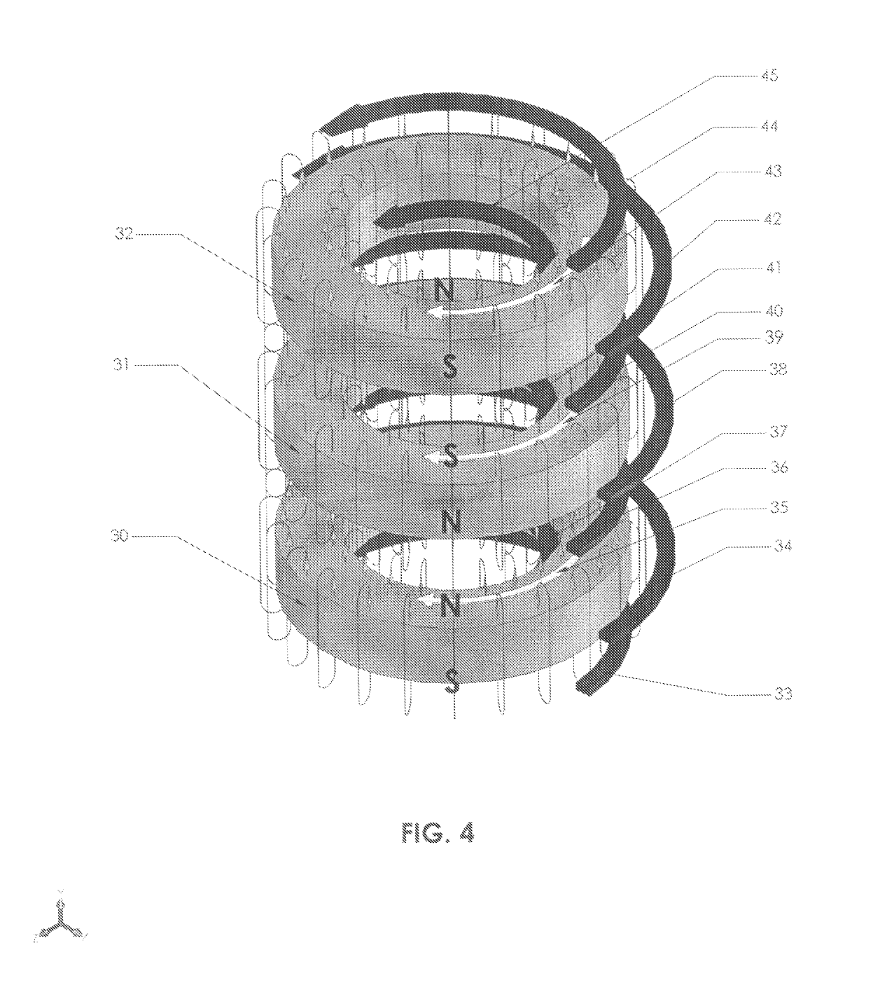

Referring to FIG. 4, a schematic diagram showing fluid flows along annular surfaces of a stack of ring magnets with same pole facing each other in clockwise direction and the stack of ring magnets being driven to spin in anti-clockwise direction. A stack of ring magnets consists of 3 ring magnets, namely ring magnet 30, ring magnet 31 and ring magnet 32 with same pole facing each other such that the strength of magnetic line of force are distributed more evenly on the four annular surfaces. It is preferable to have fluid flows along the four annular surfaces. For ring magnet 30, arrow 33, arrow 34, arrow 36 and arrow 37 showing fluid flows along lower annular surface, outer annular surface, upper annular surface and inner annular surface, respectively, with ring magnet 30 being driven to spin in a direction opposite to the direction of fluid flow as shown by arrow 35. For ring magnet 31, arrow 36, arrow 38, arrow 40 and arrow 41 showing fluid flows along lower annular surface, outer annular surface, upper annular surface and inner annular surface, respectively, with ring magnet 31 being driven to spin in a direction opposite to the direction of fluid flow as shown by arrow 39. For ring magnet 32, arrow 40, arrow 42, arrow 44 and arrow 45 showing fluid flows along lower annular surface, outer annular surface, upper annular surface and inner annular surface respectively with ring magnet 32 being driven to spin in a direction opposite to the direction to fluid flow as shown by arrow 43.

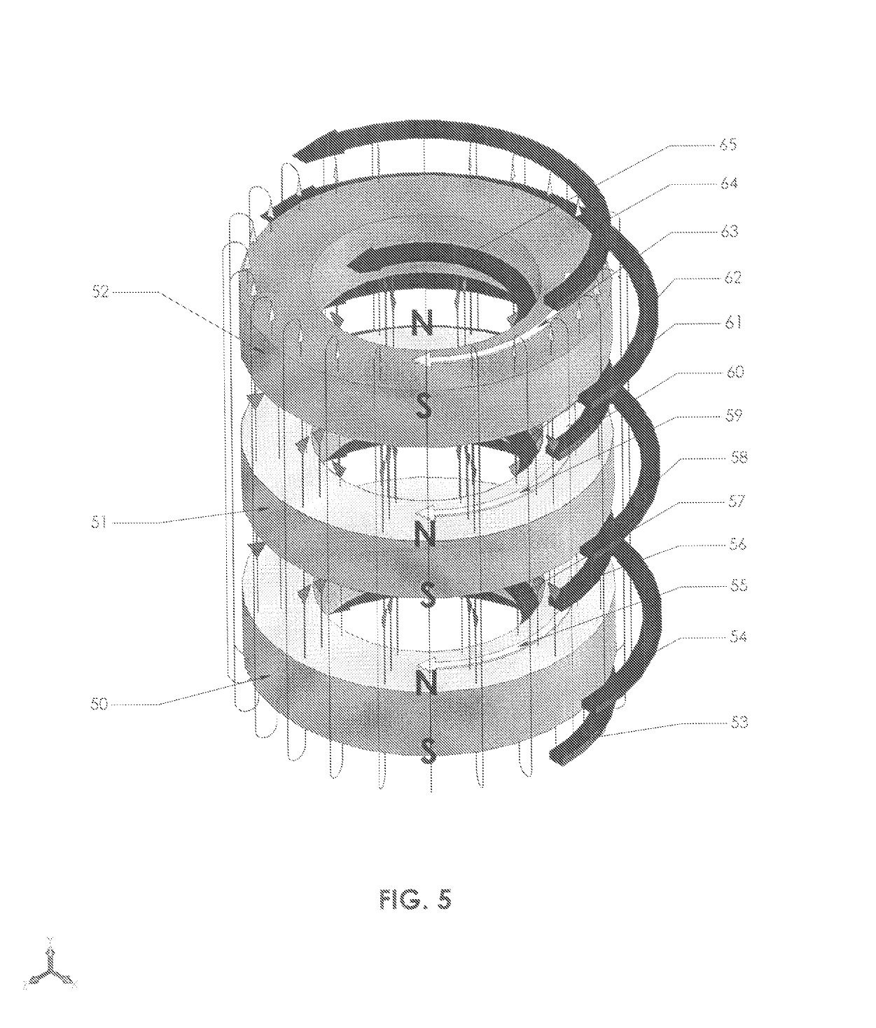

Referring to FIG. 5, a schematic diagram showing fluid flows along annular surfaces of a stack of ring magnets with opposite pole facing each other in clockwise direction and the stack of ring magnets being driven to spin in anti-clockwise direction. It is same as FIG. 4 but ring magnets 50, 51 and 52 are arranged in such a way that opposite poles are facing each other such that the strength of magnetic line of force is stronger on the upper and lower annular surfaces than that on the outer and inner annular surfaces. It is preferable to have fluid flows only along the upper and lower annular surfaces of the ring magnet.

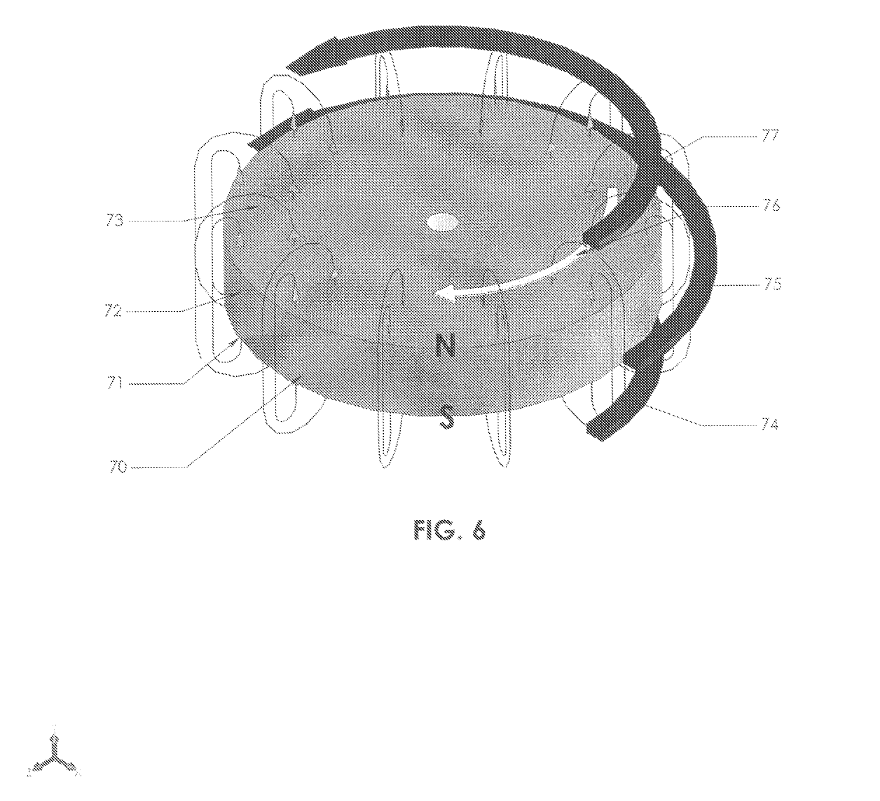

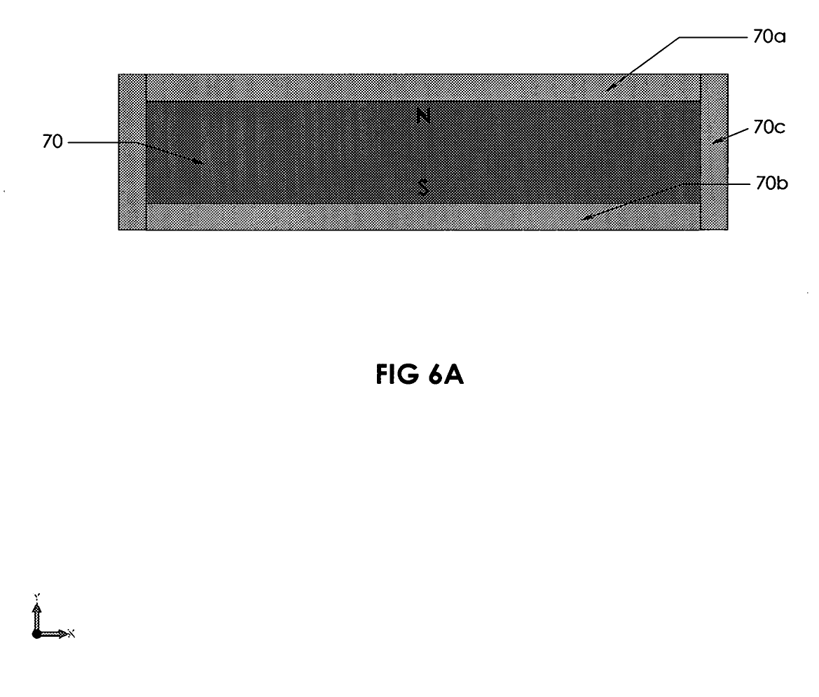

Referring to FIG. 6, a schematic diagram showing fluid flows along annular surfaces of a disc magnet in clockwise direction and the disc magnet being driven to spin in anti-clockwise direction. Disc magnet 70 has three annular surfaces, namely lower annular surface 71, outer annular surface 72 and upper annular surface 73. Arrow 74, arrow 75 and arrow 77 showing fluids flow along lower annular surface 71, outer annular surface 72 and upper annular surface 73, respectively, with disc magnet 70 is driven to spin in a direction opposite to the direction of fluid flow as shown by arrow 76.

Referring to FIG. 6A, a cross-sectional view of a disc magnet with covers. As stated earlier, some magnet materials are more powerful (such as neodymium iron boron (Nd—Fe—B) which is 10 times more powerful) than common magnet materials (such as ferrite) but get rusting easily. Therefore, protection is necessary. As shown in FIG. 6A, the best way to protect the magnet without sacrificing any magnetic power is to put covers 70a and 70b using magnetic material such as ferrite on the poles of the disc magnet 70 and cover 70c using non-magnetic material such as plastic on the outer annular surface of the disc magnet 70.

Referring to FIG. 7, a schematic diagram showing fluid flows along annular surfaces of a stack of disc magnets with same pole facing each other in clockwise direction and the stack of disc magnets being driven to spin in anti-clockwise direction. A stack of disc magnets consists of 3 disc magnets namely disc magnet 80, disc magnet 81 and disc magnet 82 with same pole facing each other such that the strength of magnetic line of force are distributed more evenly on the three annular surfaces. It is preferable to have fluid flows along all three annular surfaces. For disc magnet 80, arrow 83, arrow 84 and arrow 86 showing fluid flows along lower annular surface, outer annular surface and upper annular surface, respectively, with disc magnet 80 being driven to spin in a direction opposite to the direction of fluid flow as shown by arrow 85. For disc magnet 81, arrow 86, arrow 87 and arrow 89 showing fluid flows along lower annular surface, outer annular surface and upper annular surface respectively with disc magnet 81 being driven to spin in a direction opposite to the direction of fluid flow as shown by arrow 88. For disc magnet 82, arrow 89, arrow 90 and arrow 92 showing fluid flows along lower annular surface, outer annular surface and upper annular surface respectively with disc magnet 82 being driven to spin in a direction opposite to the direction to fluid flow as shown by arrow 91.

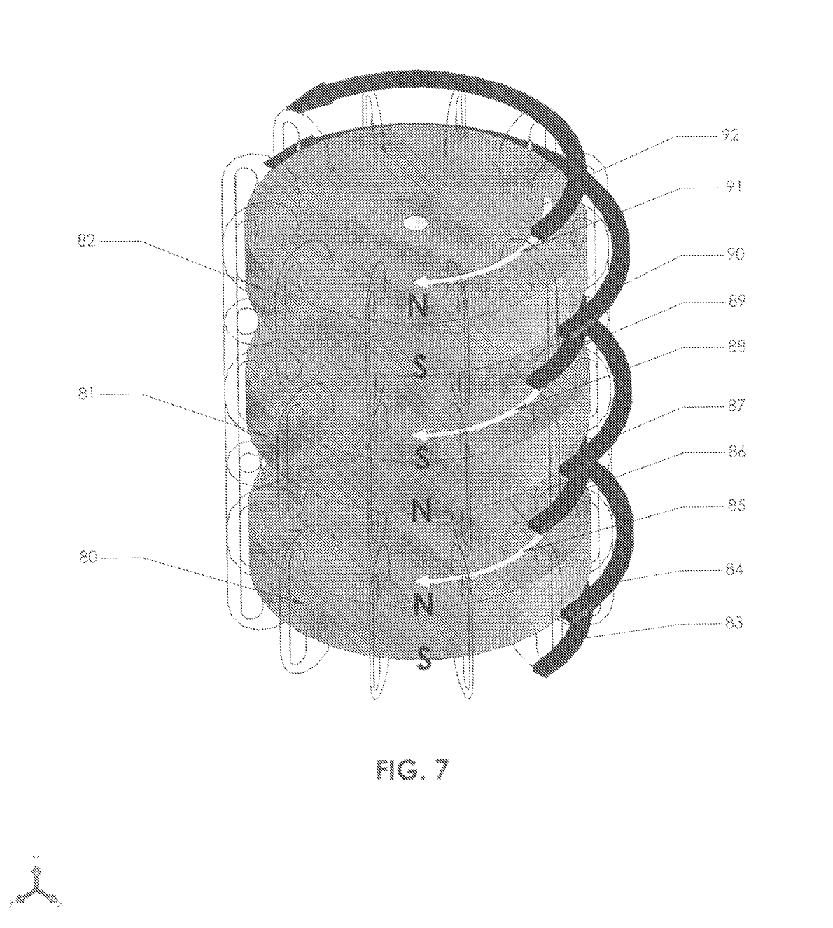

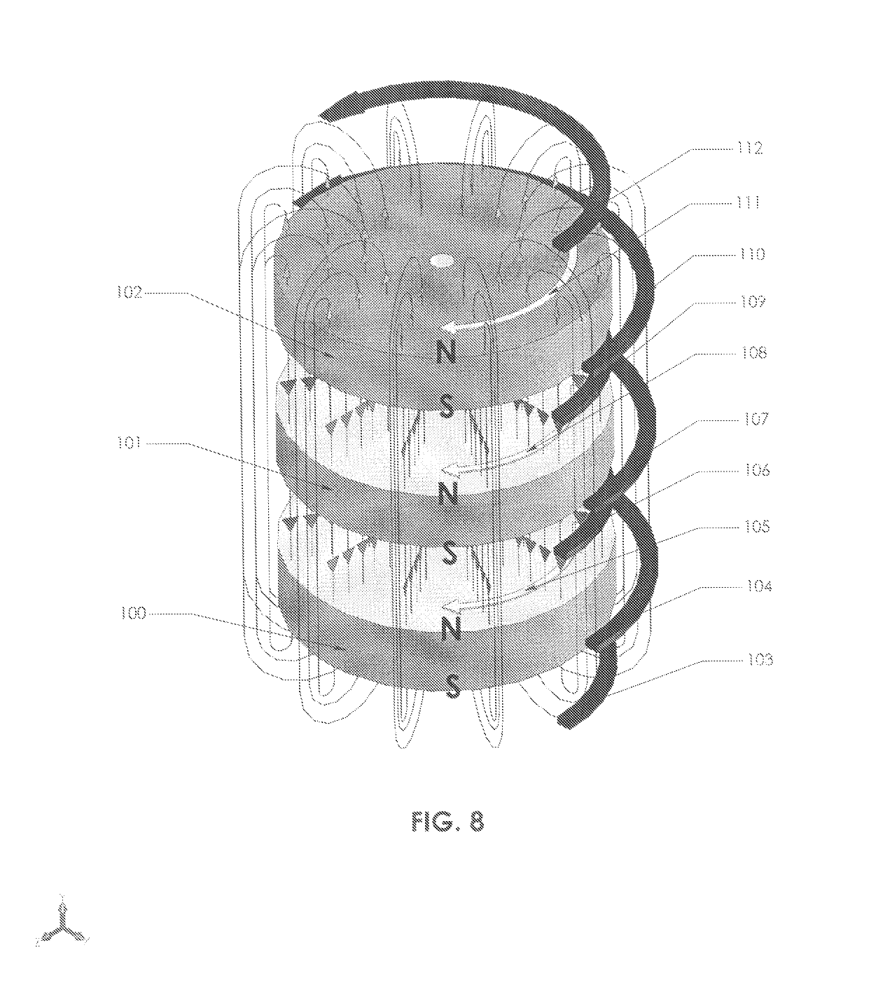

Referring to FIG. 8, a schematic diagram showing fluid flows along annular surfaces of a stack of disc magnets with opposite pole facing each other in clockwise direction and the stack of disc magnets being driven to spin in anti-clockwise direction. It is same as FIG. 7 but disc magnets 100, 101 and 102 are arranged in such a way that opposite poles are facing each other such that the strength of magnetic line of force is stronger on the upper and lower annular surfaces than that on the outer annular surface. It is preferable to have fluid flows along only the upper and lower annular surfaces of the disc magnets.

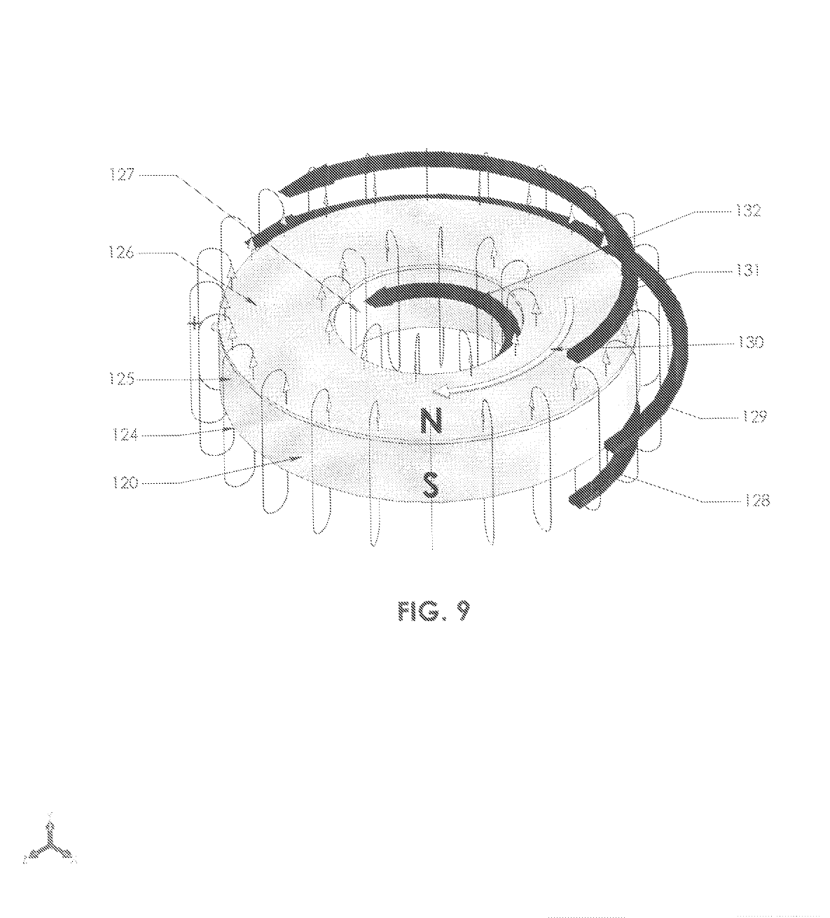

Referring to FIG. 9, a schematic diagram showing fluid flows along annular surfaces of a ring-shaped electromagnet in clockwise direction and the ring-shaped electromagnet being driven to spin in anti-clockwise direction. Ring-shaped electromagnet 120 has four annular surfaces, namely lower annular surface 124, outer annular surface 125, upper annular surface 126 and inner annular surface 127. Arrow 128, arrow 129, arrow 131 and arrow 132 showing fluid flows along lower annular surface 124, outer annular surface 125, upper annular surface 126 and inner annular surface 127, respectively, with ring-shaped electromagnet 120 being driven to spin in a direction opposite to the direction of fluid flow as shown by arrow 130.

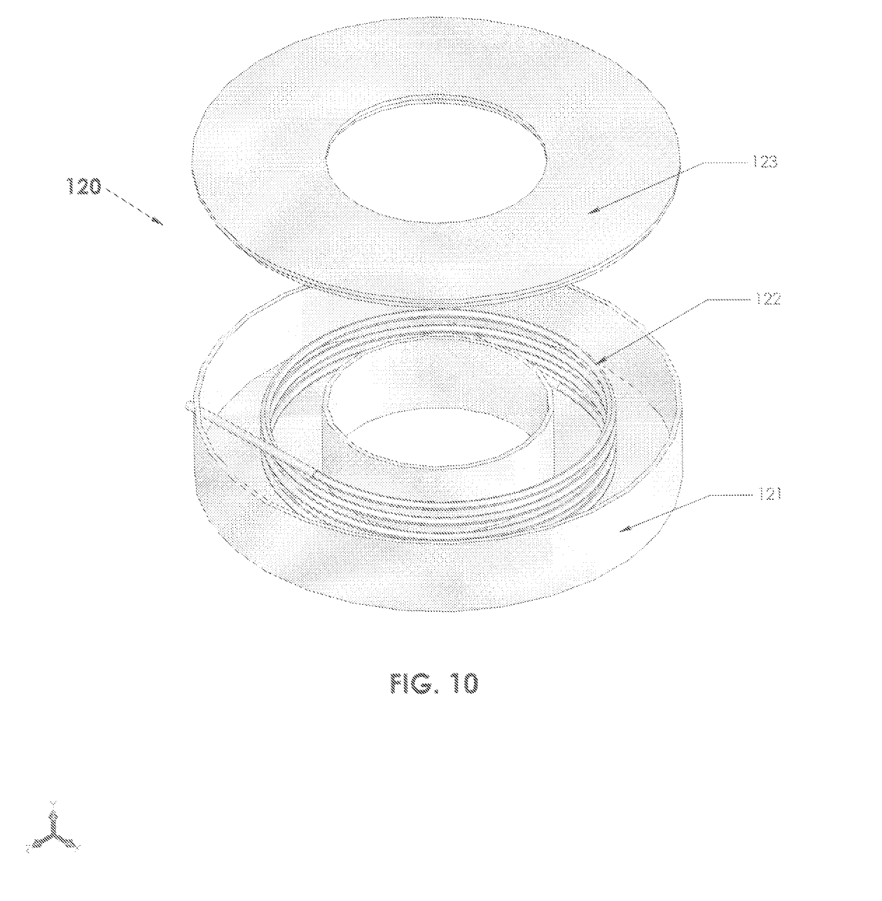

Referring to FIG. 10, an exploded view of a preferred embodiment of a ring-shaped electromagnet. A ring-shaped electromagnet 120 consists of electric coil 122, housing 121 and housing cover 123.

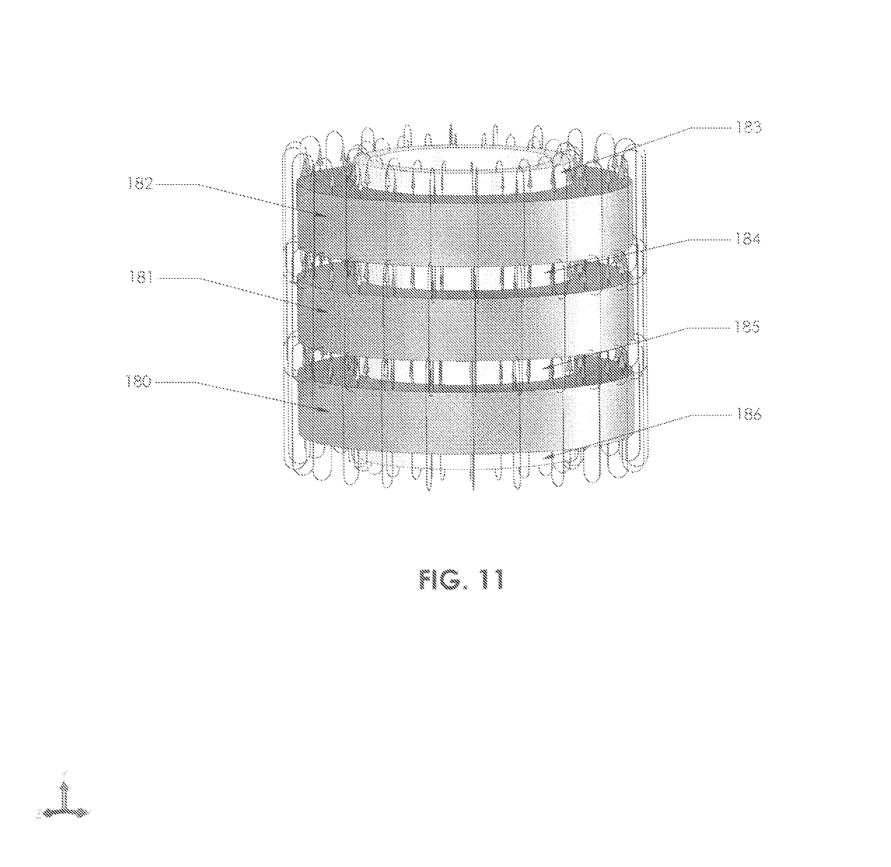

Referring to FIG. 11, an assembly of a stack of ring magnets with an insert provided therebetween. A stack of ring magnets consists of ring magnet 180, ring magnet 181 and ring magnet 182. Insert 186, insert 185, insert 184 and insert 183 are placed in between each ring magnet as shown in FIG. 11.

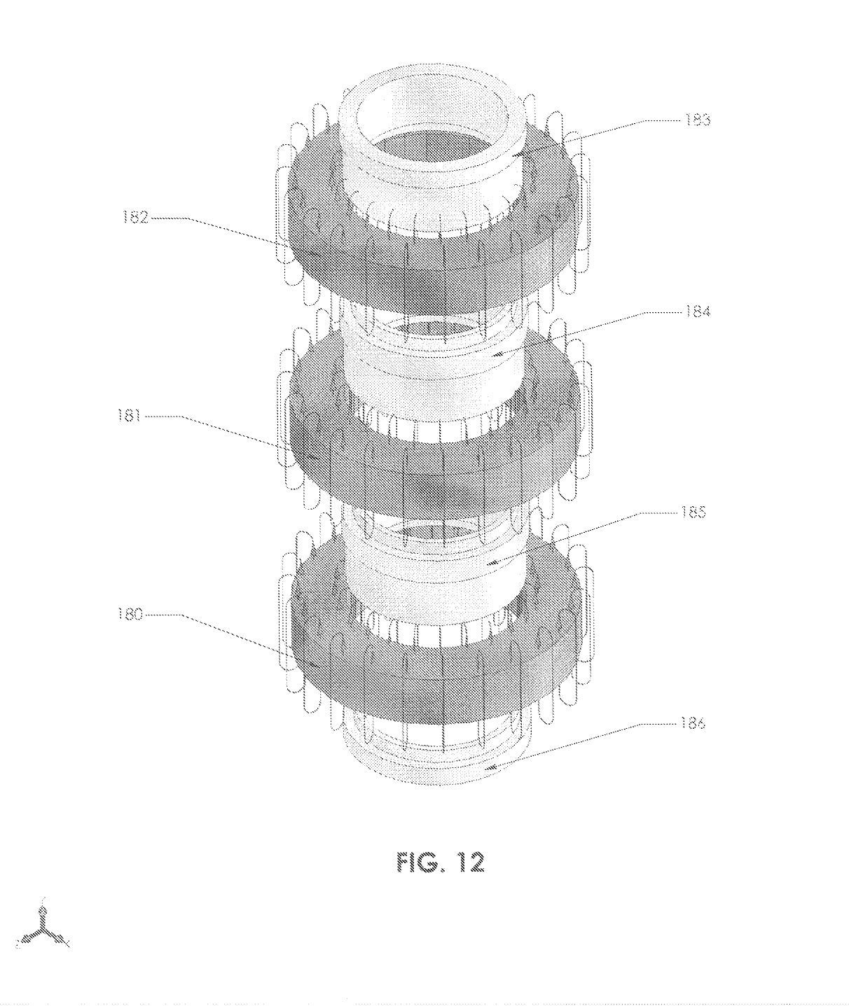

Referring to FIG. 12, an exploded view of a preferred embodiment of a stack of ring magnets with an insert provided therebetween as shown in FIG. 11. The embodiment of a stack of ring magnets can be replaced by an embodiment of a stack of ring-shaped electromagnets with an insert provided therebetween.

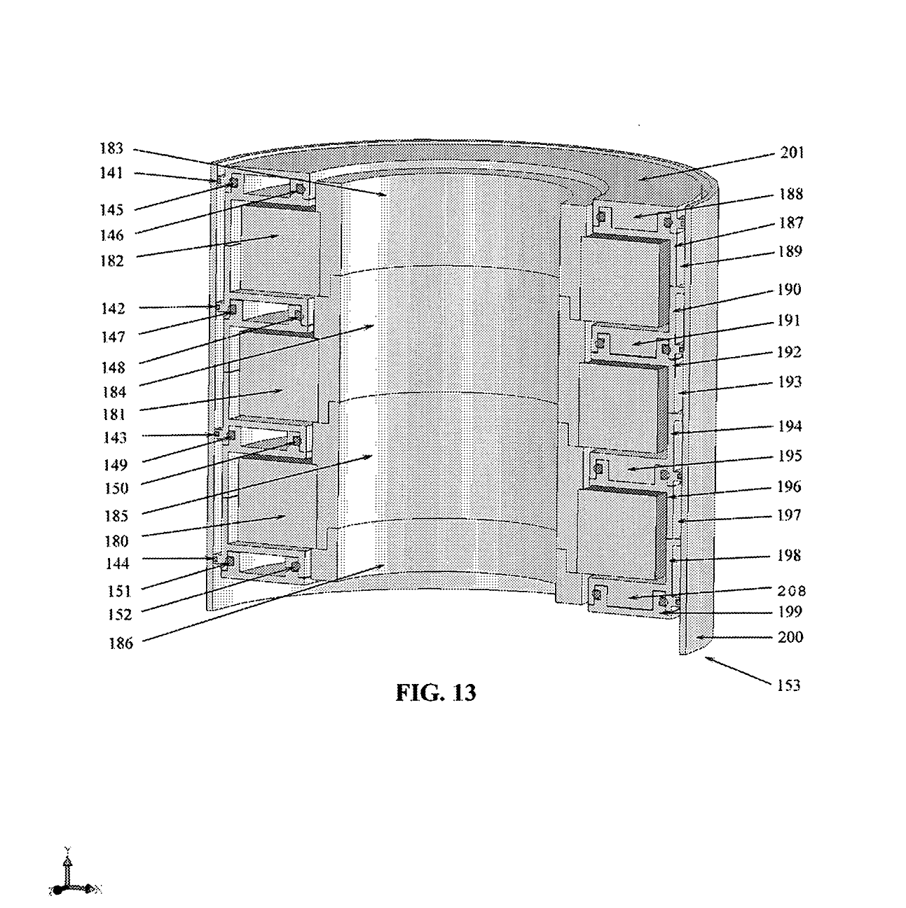

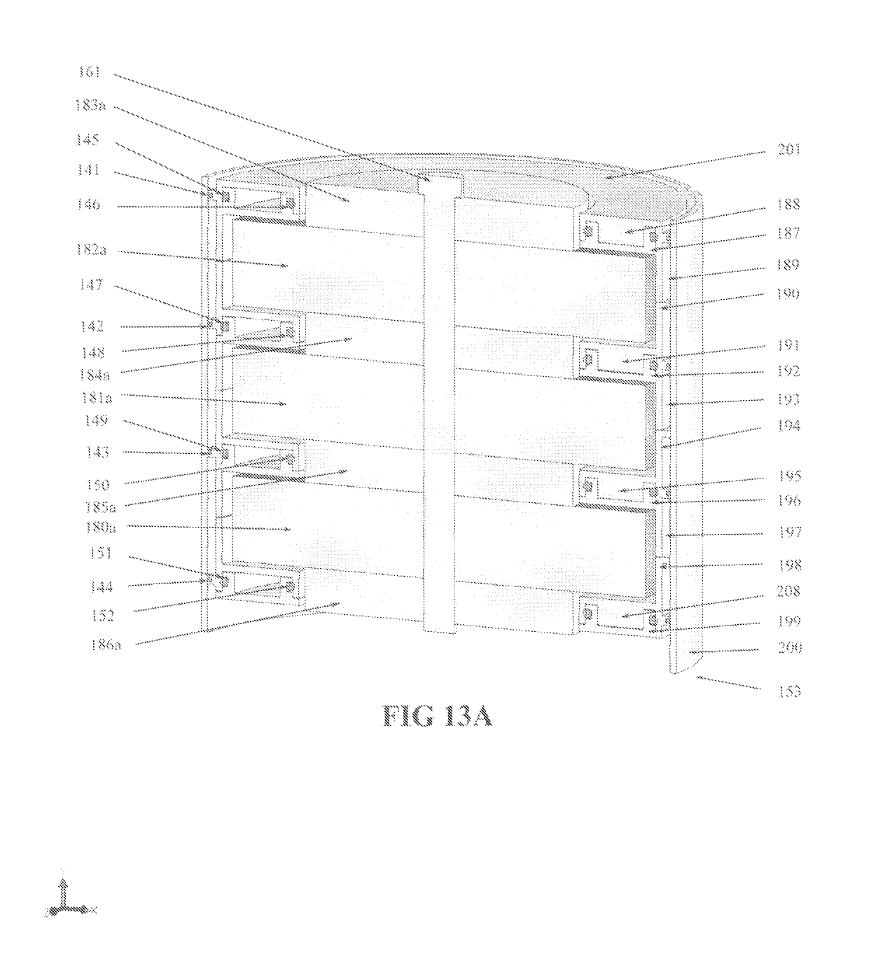

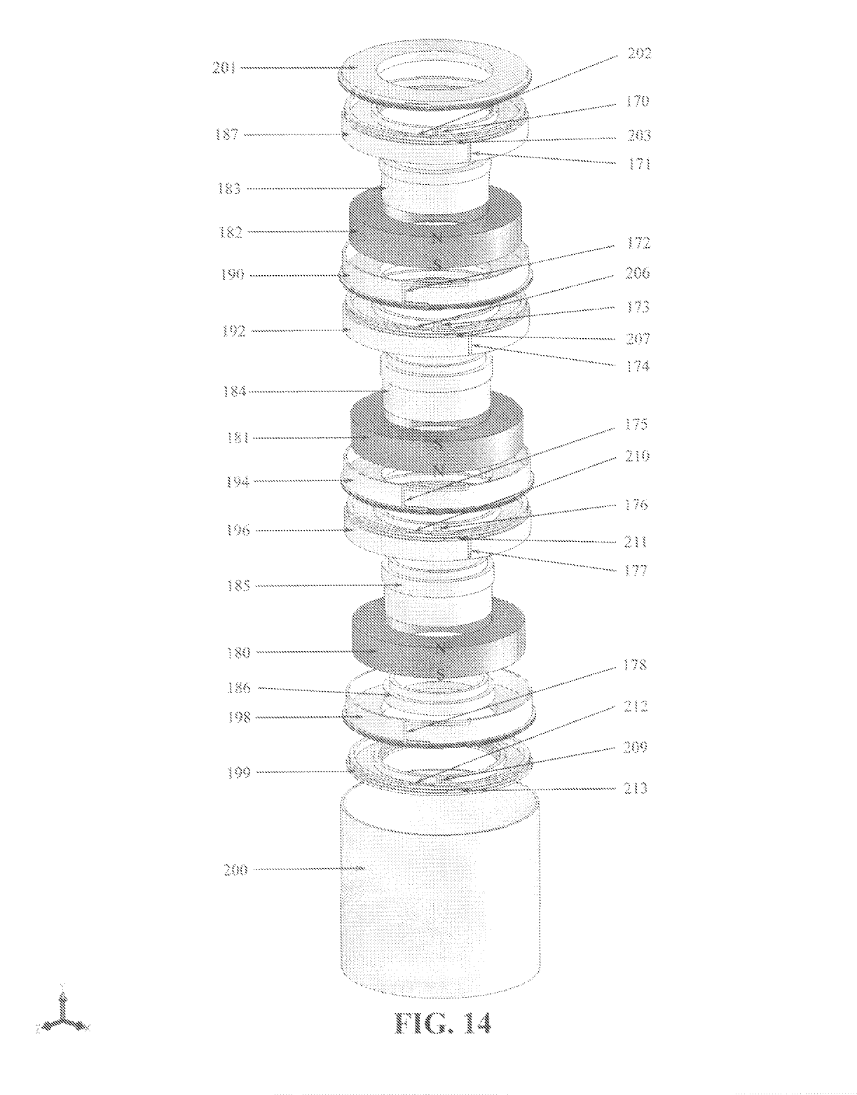

Referring to FIG. 13, a cross-sectional view of a stack of ring magnets with an insert provided therebetween and a separate housing to allow fluid passing in series through along three annular surfaces of each ring magnet. In this Figure, it shows the preferred embodiment of the present invention, which is a fluid treatment unit comprising a housing 153 having an outer wall 200, a top partition 201 and a bottom partition 199 which define a chamber within the outer wall 200. The housing 153 has a central longitudinal axis and a pair of opposite ends spaced along the axis. The housing 153 is provided with a fluid inlet 202 at the upper end and a fluid outlet 213 at the lower end, both as shown in FIG. 14, to allow a flow of fluid through the chamber. A stack of three annular magnets is disposed in the chamber. The three annular magnets extend perpendicularly across the chamber relative to the longitudinal axis. Partitions are added on top and below each annular magnet to allow the flow of fluid flows along at least one annular surface of the annular magnet. The annular magnets may be driven to spin, preferably, in a direction opposite to the flow of fluid.

Ring magnets 180, 181 and 182 are used as an example of annular magnets in FIG. 13 and described in detail as below.

The stack of ring magnets consists of 3 ring magnets 180, 181 and 182 with inserts 186, 185, 184 and 183 being placed therebetween. There are gaps between the stack of ring magnets and housing 153 such that the stack of ring magnets with an insert provided therebetween is either driven to spin in a direction opposite to the fluid flows in series along three annular surfaces of each ring magnet within the housing 153 or stationary. As stated earlier, the ring magnets may be caused to rotatably spin directly or indirectly by a rotational means, such as by coupling with a motor or a turbine driven by the fluid flow or any other commonly acceptable methods. There are seven annual flow channels within the housing 153:
First annular flow channel 188, which allows fluid flows along the upper annular surface of ring magnet 182, is formed by partition 201 and partition 187 with O-ring 145 and O-ring 146 for sealing;
Second annular flow channel 189, which allows fluid flows along the outer annular surface of ring magnet 182, is formed by partition 187, partition 190 and outer wall 200 with O-ring 141 and O-ring 142 for sealing;
Third annular flow channel 191, which allows fluid flows along both the lower annular surface of ring magnet 182 and the upper annular surface of ring magnet 181, is formed by partition 190 and partition 192 with O-ring 147 and O-ring 148 for sealing;
Fourth annular flow channel 193, which allows fluid flows along the outer annular surface of ring magnet 181, is formed by partition 192, partition 194 and outer wall 200 with O-ring 142 and O-ring 143 for sealing;
Fifth annular flow channel 195, which allows fluid flows along the lower annular surface of ring magnet 181 and the upper annular surface of ring magnet 180, is formed by partition 194 and partition 196 with O-ring 149 and O-ring 150 for sealing;
Sixth annular flow channel 197, which allows fluid flows along the outer annular surface of ring magnet 180, is formed by partition 196, partition 198 and outer wall 200 with O-ring 143 and O-ring 144 for sealing; and
Seventh annular flow channel 208, which allows fluid flows along the lower annular surface of ring magnet 180, is formed by partition 198 and partition 199 with O-ring 151 and O-ring 152 for sealing.

Although FIG. 13 shows a configuration of a stack of three ring magnets, the configuration can be easily modified to either one ring magnet or a stack of four or more ring magnets. With modification, a stack of ring-shaped electromagnets can replace the stack of ring magnets in accordance with the configuration disclosed in the present invention and the result is the same as herein disclosed.

Referring to FIG. 13A, a cross-sectional view of a stack of disc magnets with an insert provided therebetween and a separate housing to allow fluid passing in series through along three annular surfaces of each ring magnet. The set up of the treatment unit is exactly the same as shown in FIG. 13, except a stack of disc magnets replaces the stack of ring magnets. The stack of disc magnets consists of three disc magnets 180a, 181a and 182a with inserts 186a, 185a, 184a and 183a therebetween and hold together by a pin 161.

Referring to FIG. 14, an exploded view of a preferred embodiment of a stack of ring magnets with an insert provided therebetween and a separate housing to allow fluid passing in series through three annular surfaces of each ring magnet. Fluid enters the first annular channel 188 through inlet 202 flows in clockwise direction until blocked by projection 170 and then exits through outlet 203. Fluid continues to flow into the second annular channel 189 in clockwise direction until blocked by projection 171 and projection 172 and then exits through inlet 206 of third annular channel 191. Fluid continues to flow into the third annular channel 191 in clockwise direction until blocked by projection 173 and then exits through outlet 207 of third annular channel 191. Fluid continues to flow into the fourth annular channel 193 in clockwise direction until blocked by projection 174 and projection 175 and then exits through inlet 210 of fifth annular channel 193. Fluid continues to flow into the fifth annular channel 195 in clockwise direction until blocked by projection 176 and then exits through outlet 211 of fifth annular channel 191. Fluid continues to flow into the sixth annular channel 197 in clockwise direction until blocked by projection 177 and projection 178 and then exits through inlet 212 of seventh annular channel 178. Fluid continues to flow into the seventh annular channel 208 in clockwise direction until blocked by projection 209 and then exits through outlet 213 of the seventh annular channel 178. The various channels described herein are shown in FIG. 13A.

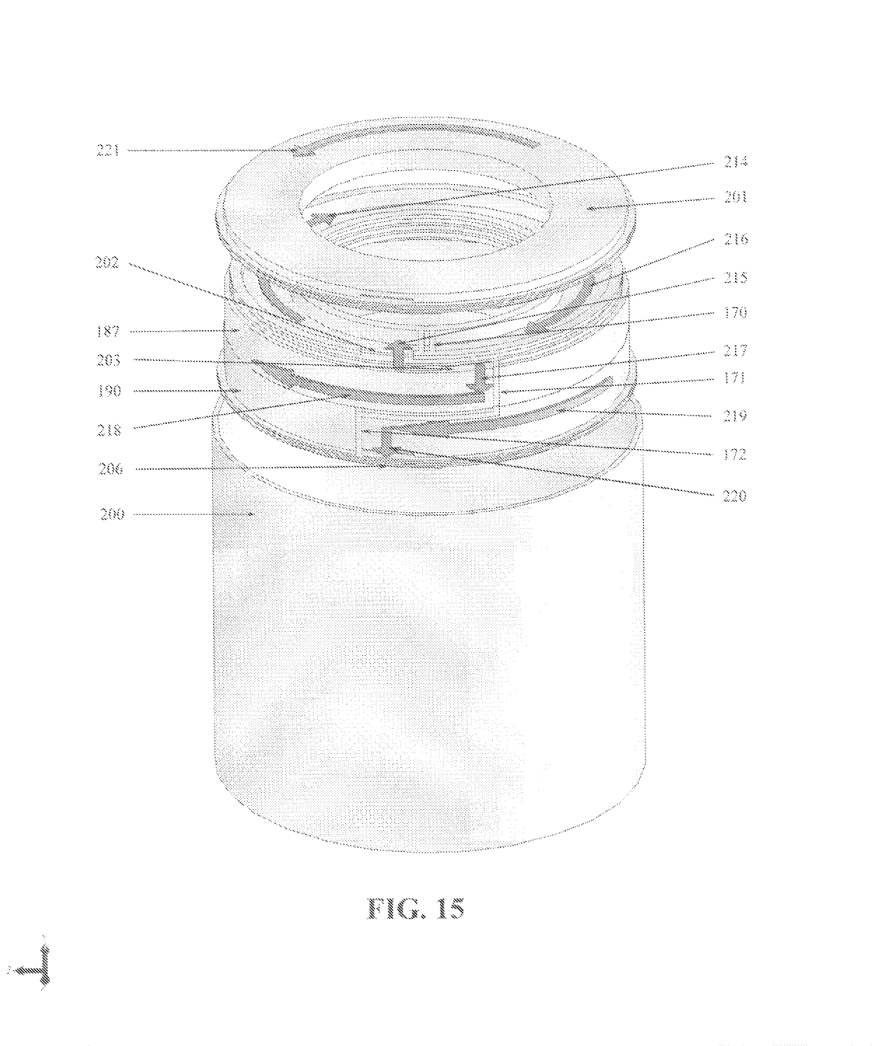

Referring to FIG. 15, an exploded view of a preferred embodiment of a separate housing to allow fluid passing in series through the upper, outer and lower annular surfaces of each ring magnet without showing the stack of ring magnets with an insert provided therebetween. Arrow 221 showing the stack of ring magnets with an insert provided therebetween and is being driven to spin in an anticlockwise direction or stationary. Arrow 215 showing fluid enters the first annular channel 188 through inlet 202 flows in a clockwise direction as shown by arrows 214 and 216 until blocked by projection 170 and then exits through outlet 203. Fluid continues to flow into the second annular channel 189 in clockwise direction as shown by arrows 217, 218, 219 and 220 until blocked by projection 171 and projection 172 and then exits through inlet 206 of third annular channel 191. The above detailed description of how fluid flows along the annular surfaces of the ring magnet 182 also applies to the ring magnets 181 and 180.

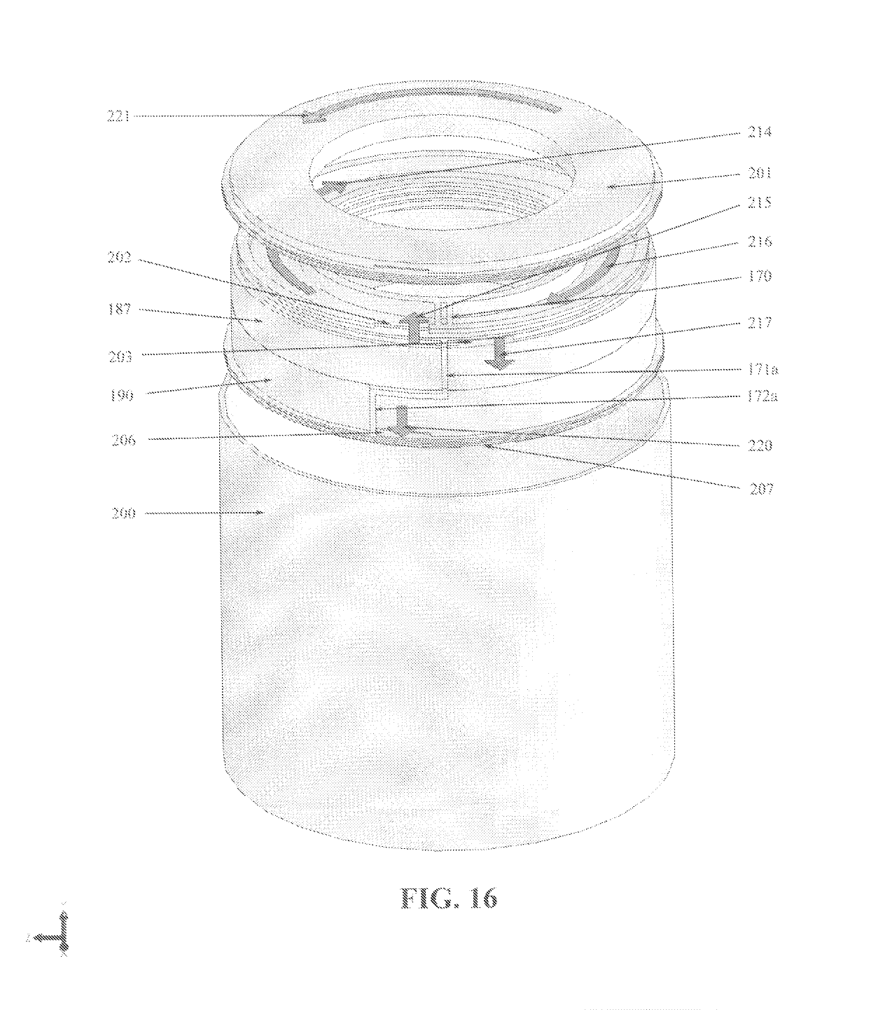

Referring to FIG. 16, an exploded view of a preferred embodiment of a separate housing to allow fluid passing in series through the upper and lower annular surfaces of each ring magnet without showing the stack of ring magnets with an insert provided therebetween. Arrow 221 showing the stack of ring magnets with an insert provided therebetween and is being driven to spin in an anticlockwise direction or stationary. Arrow 215 showing fluid enters the first annular channel 188 through inlet 202 flows in a clockwise direction as shown by arrows 214 and 216 until blocked by projection 170 and then exits through outlet 203. Fluid flow is blocked by projection 171a and projection 172a and bypassing the second annular channel 189. Fluid exits through inlet 206 of third annular channel 191 as shown by arrows 217 and 220. The above detailed description of how fluid flows along the annular surfaces of the ring magnet 182 also applies to the ring magnets 181 and 180.

Referring to FIG. 14 again, fluid will bypass the third annular channel 191 and the seventh annular channel 208 if the projection 173 and projection 209 are removed. Therefore, fluid flows through only the north poles of the ring magnets. Furthermore, if the projection 170 is also removed, fluid will flow through only the annular channel with north poles on both side of the annular channel. Similarly, fluid will bypass the first annular channel 188 and the fifth annular channel 195 if the projection 170 and projection 176 are removed. Therefore, fluid flows through only the south poles of the ring magnets. Furthermore, if the projection 209 is also removed, fluid will flow through only the annular channel with south poles on both side of the annular channel.

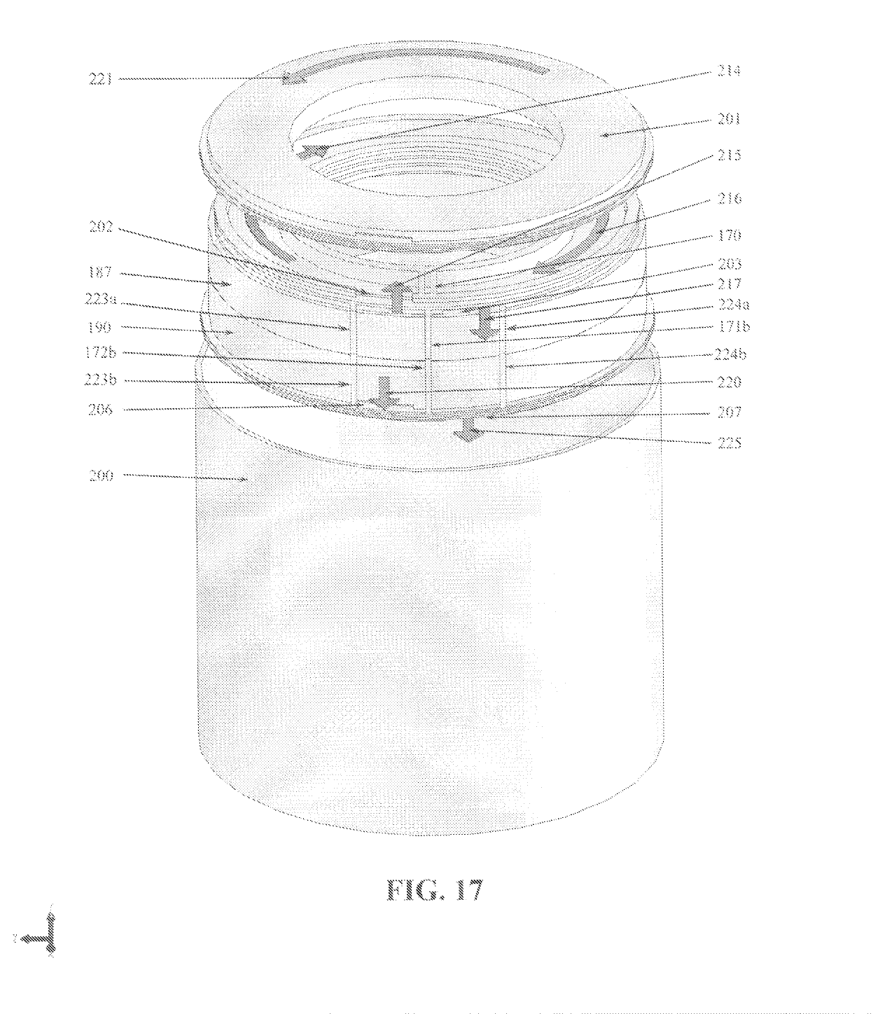

Referring to FIG. 17, an exploded view of a preferred embodiment of a separate housing to allow fluid passing in parallel through the upper and lower annular surfaces of each ring magnet without showing the stack of ring magnets with an insert provided therebetween. Arrow 221 showing the stack of ring magnets with an insert provided therebetween and is being driven to spin in an anticlockwise direction or stationary. Fluid flow is blocked by additional of projection 223a, 223b, 224a and 224b and thus bypass the second annular channel 189. With projection 171b and projection 172b, arrows 215 and 220 showing fluid flows simultaneously into the first annular channel 188 and the third annular channel 191 through inlet 202 and inlet 206, respectively. Fluid continues to flow in a clockwise direction until blocked by projections 170 and 173. Arrows 217 and 225 showing fluid exits through outlet 203 and outlet 207, respectively. The above detailed description of how fluid flows along the annular surfaces of the ring magnets 182 and 181 also applies to the ring magnets 182, 181 and 180.

Referring to FIG. 14 again, fluid will bypass the third annular channel 191 and the seventh annular channel 208 if the inlet 206 and inlet 212 are removed. Therefore, fluid flows through only the north poles of the ring magnets. Furthermore, if the inlet 202 is also removed, fluid will flow through only the annular channel with north poles on both sides of the annular channel. Similarly, fluid will bypass the first annular channel 188 and the fifth annular channel 195 if the inlet 202 and inlet 210 are removed. Therefore, fluid flows through only the south poles of the ring magnets. Furthermore, if the inlet 212 is also removed, fluid will flow through only the annular channel with south poles on both sides of the annular channel.

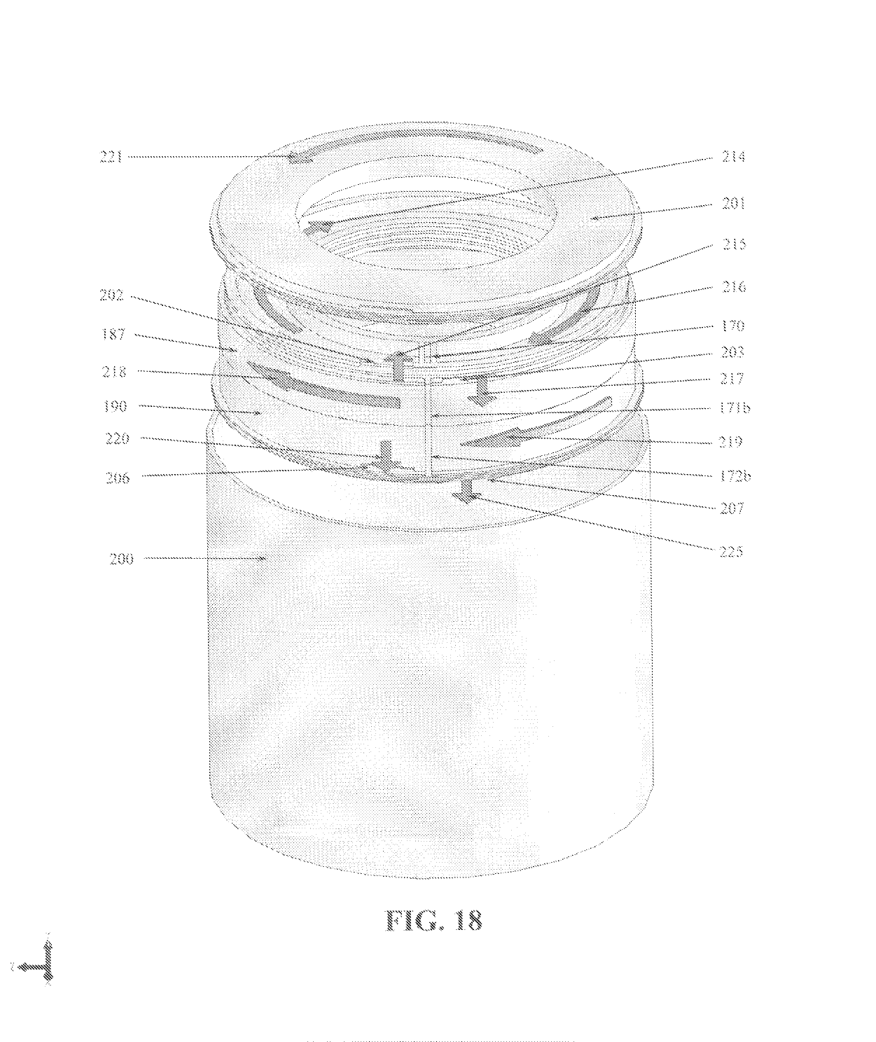

Referring to FIG. 18, an exploded view of a preferred embodiment of a separate housing to allow fluid passing in parallel through the upper, outer and lower annular surfaces of all ring magnets without showing the stack of ring magnets with an insert provided therebetween. Arrow 221 showing the stack of ring magnets with an insert provided therebetween and is being driven to spin in an anticlockwise direction or stationary. With projection 171b and projection 172b, arrows 215, 218 and 220 showing fluid flows simultaneously into the first annular channel 188, the second annular channel 189 and the third annular channel 191 through inlet 202, space in between inlet 202 and inlet 206, respectively. Fluid continues to flow in a clockwise direction until blocked by partitions 170, 171b, 172b and 173. Arrows 217, 219 and 225 showing fluid exits through outlet 203, space in between outlet 203 and outlet 207, respectively. The above detailed description of how fluid flows along the annular surfaces of the ring magnets 182 and 181 also applies to the ring magnets 182, 181 and 180.

It is understood that new configuration of stack of ring magnets can be created by adding FIGS. 15, 16, 17 and 18 in any combination.

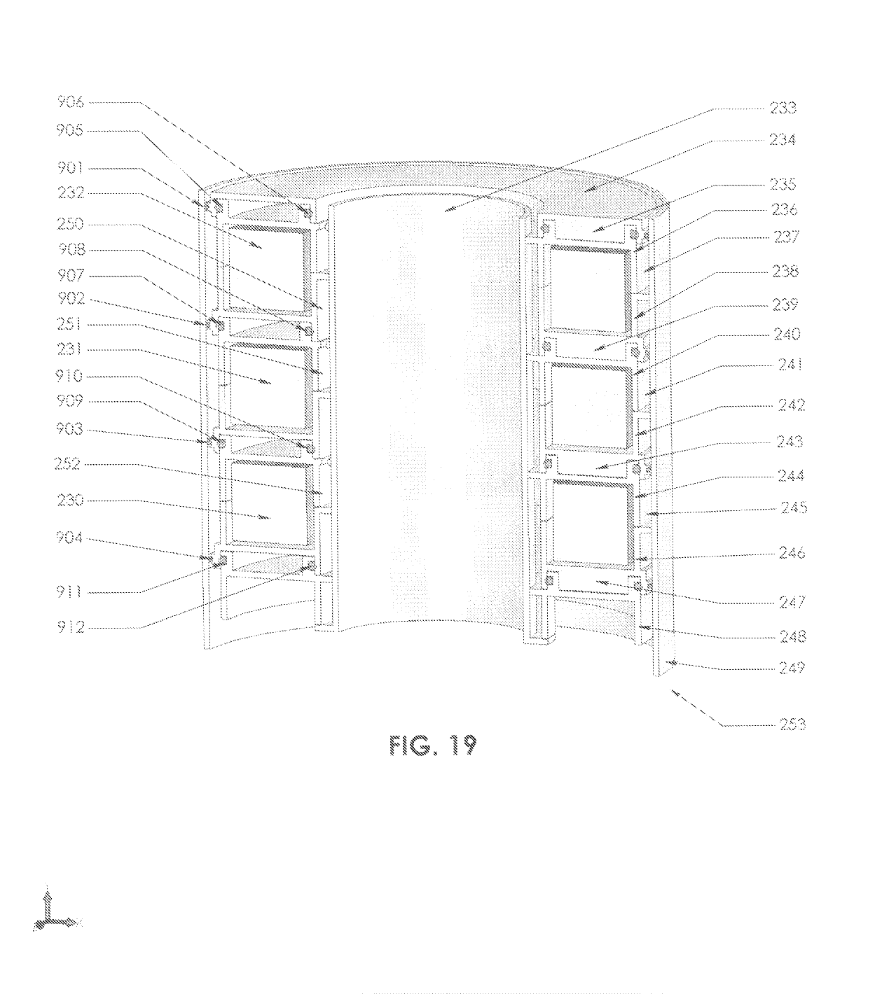

Referring to FIG. 19, a cross-sectional view of a stack of ring magnets and a separate housing to allow fluid passing in series through four annular surfaces of each ring magnet. The stack of ring magnets with an insert provided therebetween is stationary. There are ten annual flow channels within the housing 253:
First annular flow channel 235, which allows fluid flows along the upper annular surface of ring magnet 232, is formed by partition 234 and partition 236 with O-ring 905 and O-ring 906 for sealing;
Second annular flow channel 237, which allows fluid flows along the outer annular surface of ring magnet 232, is formed by partition 236, partition 238 and outer wall 249 with O-ring 901 and O-ring 902 for sealing;
Third annular flow channel 239, which allows fluid flows along both the lower annular surface of ring magnet 232 and the upper annular surface of ring magnet 231, is formed by partition 238 and partition 240 with O-ring 907 and O-ring 908 for sealing;
Fourth annular flow channel 241, which allows fluid flows along the outer annular surface of ring magnet 231, is formed by partition 240, partition 242 and outer wall 249 with O-ring 902 and O-ring 903 for sealing;
Fifth annular flow channel 243, which allows fluid flows along the lower annular surface of ring magnet 231 and the upper annular surface of ring magnet 230, is formed by partition 242 and partition 244 with O-ring 909 and O-ring 910 for sealing;
Sixth annular flow channel 245, which allows fluid flows along the outer annular surface of ring magnet 230, is formed by partition 244, partition 246 and outer wall 249 with O-ring 903 and O-ring 904 for sealing;
Seventh annular flow channel 247, which allows fluid flows along the lower annular surface of ring magnet 230, is formed by partition 246 and partition 248 with O-ring 911 and O-ring 912 for sealing;
Eighth annular flow channel 252, which allows fluid flows along the inner annular surface of ring magnet 230, is formed by partition 244, partition 246, partition 248 and inner wall 233 with tight fitted for sealing without any O-ring;
Ninth annular flow channel 251, which allows fluid flows along the inner annular surface of ring magnet 231, is formed by partition 240, partition 242, partition 244 and inner wall 233 with tight fitted for sealing without any O-ring; and
Tenth annular flow channel 250, which allows fluid flows along the inner annular surface of ring magnet 232, is formed by partition 236, partition 238, partition 240 and inner wall 233 with tight fitted for sealing without any O-ring.

Although FIG. 19 shows a configuration of a stack of three ring magnets, the configuration can be easily modified to either one ring magnet or a stack of four or more ring magnets. With modification, a stack of ring-shaped electromagnets can replace the stack of ring magnets in accordance with the configuration disclosed in the present invention and the result is the same as herein disclosed.

As shown in FIG. 19, the three ring magnets are not touching the partitions. With modification, the gaps in between the partitions and the annular surfaces of the ring magnets can be reduced to zero, thus removing the material of the portion of the partitions which touches the annular surfaces of the ring magnets, fluid flow then touches the annular surfaces of the ring magnets and achieves better effectiveness.

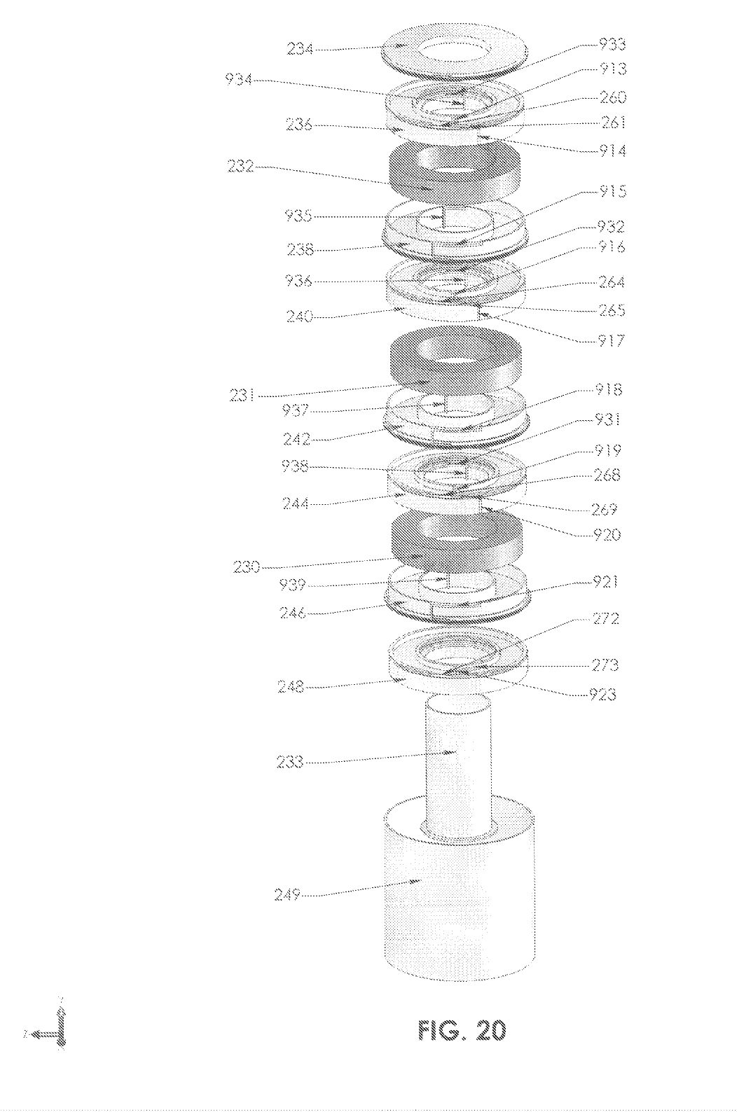

Referring to FIG. 20, an exploded view of a preferred embodiment of a separate housing to allow fluid passing in series through four annular surfaces of each ring magnet. Fluid enters the first annular channel 235 through inlet 260 and flows in clockwise direction until blocked by projection 913 and then exits through outlet 261. Fluid continues to flow into the second annular channel 237 in clockwise direction until blocked by projection 914 and projection 915 and then exits through inlet 264 of the third annular channel 239. Fluid continues to flow into the third annular channel 239 in clockwise direction until blocked by projection 916 and then exits through outlet 265 of the third annular channel 239. Fluid continues to flow into the fourth annular channel 241 in clockwise direction until blocked by projection 917 and projection 918 and then exits through inlet 268 of the fifth annular channel 243. Fluid continues to flow into the fifth annular channel 243 in clockwise direction until blocked by projection 919 and then exits through outlet 269 of the fifth annular channel 243. Fluid continues to flow into the sixth annular channel 245 in clockwise direction until blocked by projection 920 and projection 921 and then exits through inlet 272 of the seventh annular channel 247. Fluid continues to flow into the seventh annular channel 247 in clockwise direction until blocked by projection 923 and then exits through outlet 273 of the seventh annular channel 247. Fluid continues to flow into the eighth annular channel 252 in clockwise direction until blocked by projection 938 and projection 939 and then exits through inlet 931 of the ninth annular channel 251. Fluid continues to flow into the ninth annular channel 251 in clockwise direction until blocked by projection 936 and projection 937 and then exits through inlet 932 of tenth annular channel 250. Fluid continues to flow into the tenth annular channel 250 in clockwise direction until blocked by projection 934 and projection 935 and then exits through outlet 933 of the tenth annular channel 250.

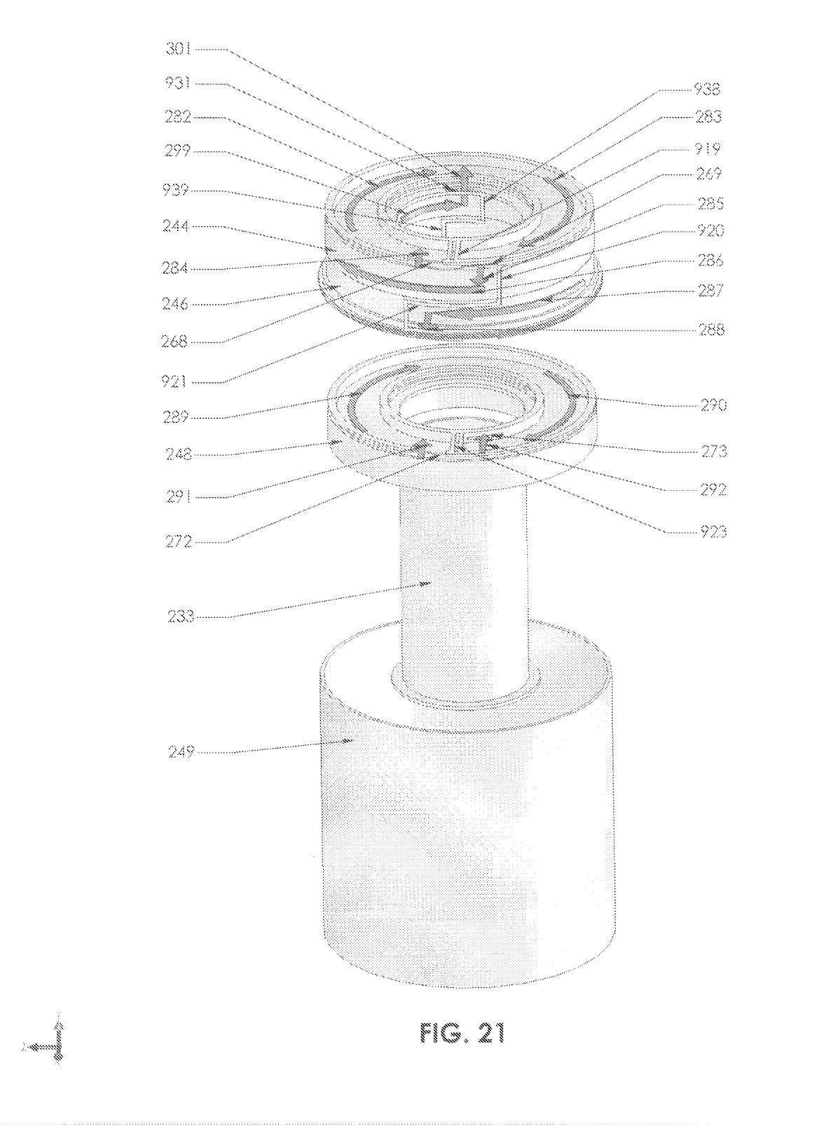

Referring to FIG. 21, an exploded view of a preferred embodiment of a separate housing to allow fluid passing in series through four annular surfaces of ring magnet 230 (not shown) without showing the stack of ring magnets. Arrow 284 showing fluid enters the fifth annular channel 243 through inlet 268 flows in a clockwise direction as shown by arrows 282 and 283 until blocked by projection 919 and then exits through outlet 269. Fluid continues to flow into the sixth annular channel 245 in clockwise direction as shown by arrows 285, 286, 287 and 288 until blocked by projection 920 and projection 921 and then exits through inlet 272 of seventh annular channel 247. Arrow 291 showing fluid enters the seventh annular channel 247 through inlet 272 flows in a clockwise direction as shown by arrows 289 and 290 until blocked by projection 923 and then exits through outlet 273. Fluid continues to flow into the eighth annular channel 252 in clockwise direction as shown by arrows 292, 299 and 301 until blocked by projection 938 and projection 939 and then exits through inlet 931 of ninth annular channel 251. The above detailed description of how fluid flows along the annular surfaces of the ring magnet 230 also applies to the ring magnets 231 and 232.

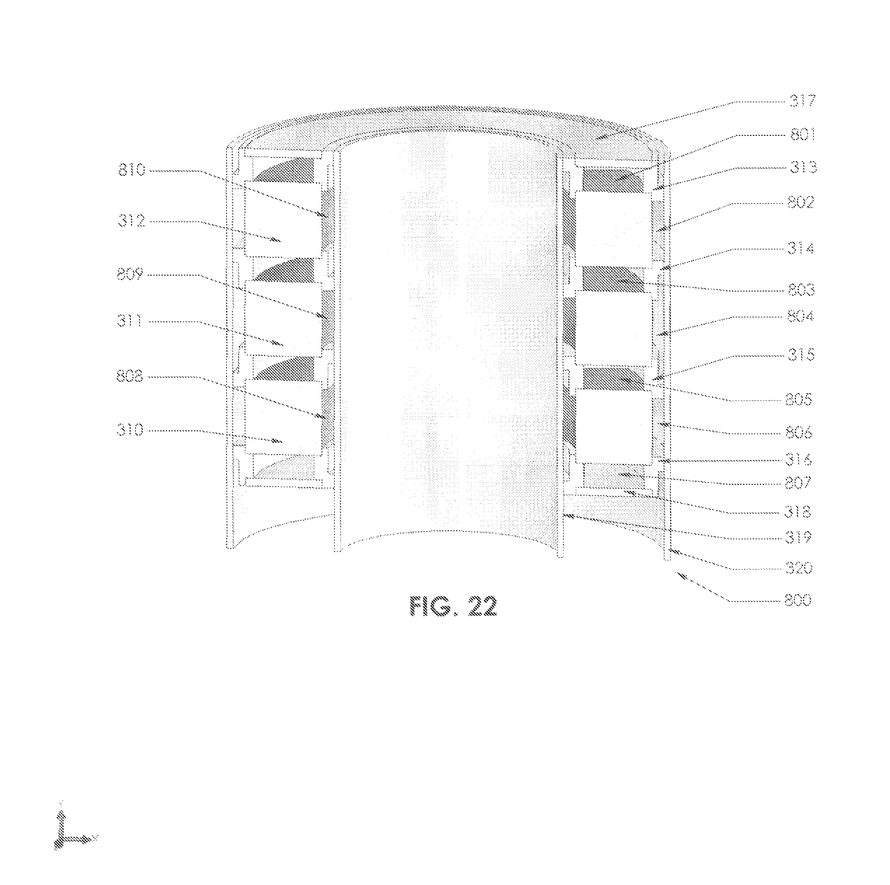

Referring to FIG. 22, a cross-sectional view of a stack of ring magnets with partitions in between and a housing to allow fluid passing in series through the upper and lower annular surfaces of each ring magnet. The stack of ring magnets is stationary. In order to maximize the effectiveness, fluid flow is touching all surfaces of all ring magnets. There are ten annual flow channels within the housing 800:
First annular flow channel 801, which allows fluid flows along the upper annular surface of ring magnet 312, is formed by partition 317, upper annular surface of ring magnet 312 and partition 313 with tight fitted for sealing without any O-ring;
Second annular flow channel 802, which allows fluid flows along the outer annular surface of ring magnet 312, is formed by partition 313, outer annular surface of ring magnet 312 partition 314 and outer wall 320 with tight fitted for sealing without any O-ring;
Third annular flow channel 803, which allows fluid flows along both the lower annular surface of ring magnet 312, and the upper annular surface of ring magnet 311, is formed by partition 314, lower annular surface of ring magnet 312 and upper annular surface of ring magnet 311 with tight fitted for sealing without any O-ring;
Fourth annular flow channel 804, which allows fluid flows along the outer annular surface of ring magnet 311, is formed by partition 314, outer annular surface of ring magnet 311, partition 315 and outer wall 320 with tight fitted for sealing without any O-ring;
Fifth annular flow channel 805, which allows fluid flows along the lower annular surface of ring magnet 311 and the upper annular surface of ring magnet 310, is formed by partition 315, lower annular surface of ring magnet 311 and upper annular surface of ring magnet 310 with tight fitted for sealing without any O-ring;
Sixth annular flow channel 806, which allows fluid flows along the outer annular surface of ring magnet 310, is formed by partition 315, outer annular surface of ring magnet 310, partition 316 and outer wall 320 with tight fitted for sealing without any O-ring;
Seventh annular flow channel 807, which allows fluid flows along the lower annular surface of ring magnet 310, is formed by partition 316, lower annular surface of ring magnet 310 and partition 318 with tight fitted for sealing without any O-ring;
Eighth annular flow channel 808, which allows fluid flows along the inner annular surface of ring magnet 310, is formed by partition 316, inner annular surface of ring magnet 310, partition 315 and inner wall 319 with tight fitted for sealing without any O-ring;
Ninth annular flow channel 309, which allows fluid flows along the inner annular surface of ring magnet 311, is formed by partition 315, inner annular surface of ring magnet 311, partition 314 and inner wall 319 with tight fitted for sealing without any O-ring;
Tenth annular flow channel 810, which allows fluid flows along the inner annular surface of ring magnet 312, is formed by partition 314, inner annular surface of ring magnet 312, partition 313 and inner wall 319 with tight fitted for sealing without any O-ring.

Although FIG. 22 shows a configuration of a stack of three ring magnets, the configuration can be easily modified to either one ring magnet or a stack of four or more ring magnets. With modification, a stack of ring-shaped electromagnets can replace the stack of ring magnets in accordance with the configuration disclosed in the present invention and the result is the same as herein disclosed.

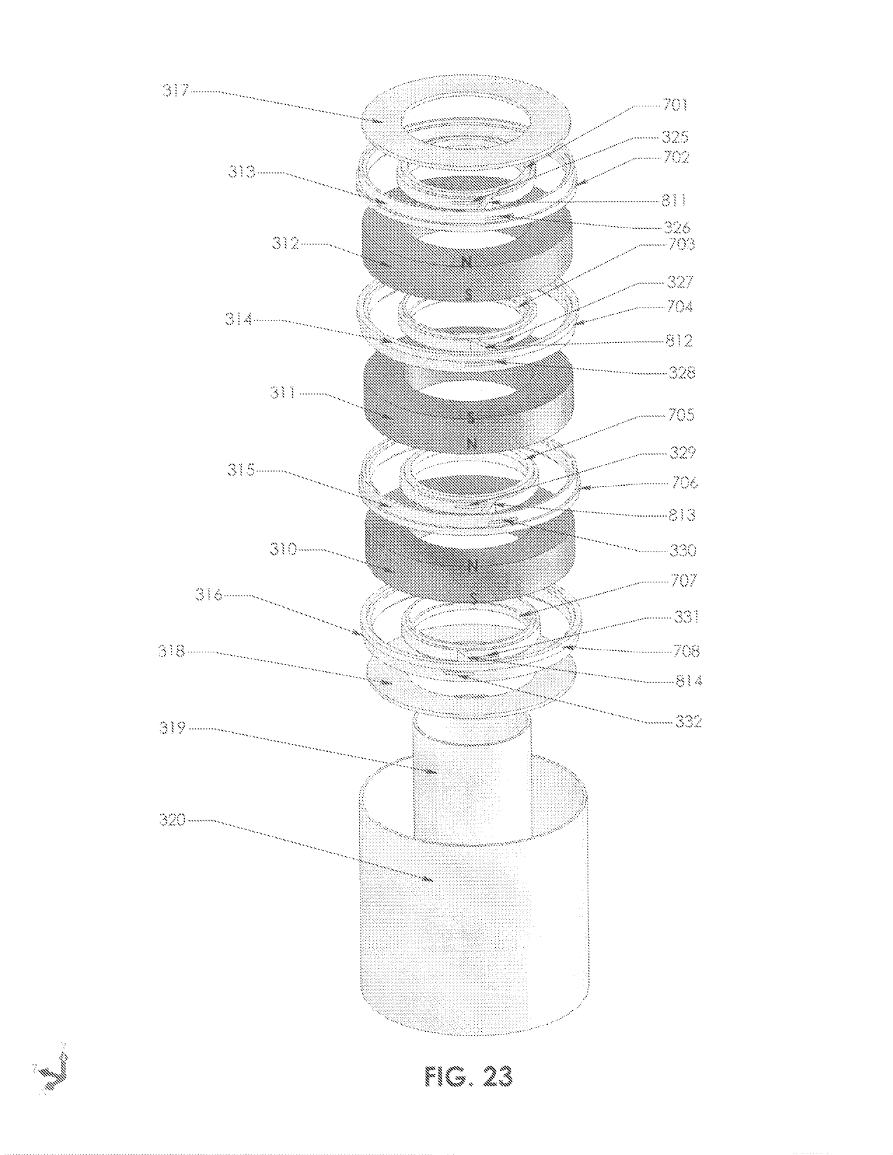

Referring to FIG. 23, an exploded view of a preferred embodiment of a stack of ring magnets with partitions in between and a housing with partitions to allow fluid passing in series through the upper and lower annular surfaces of each ring magnet. Fluid enters the first annular channel 801 through inlet 326 flows in anticlockwise direction until blocked by projection 811 and then exits through outlet 325. Fluid continues to flow, bypassing the tenth annular channel 810. Fluid continues to flow into the third annular channel 803 through inlet 327 in anticlockwise direction until blocked by projection 812 and then exits through outlet 328 of third annular channel 803. Fluid continues to flow, bypassing the fourth annular channel 804. Fluid continues to flow into the fifth annular channel 805 through inlet 330 in anticlockwise direction until blocked by projection 813 and then exits through outlet 329 of fifth annular channel 805. Fluid continues to flow, bypassing the eighth annular channel 808. Fluid continues to flow into the seventh annular channel 807 through inlet 331 in anticlockwise direction until blocked by projection 814 and then exits through outlet 332 of the seventh annular channel 807.

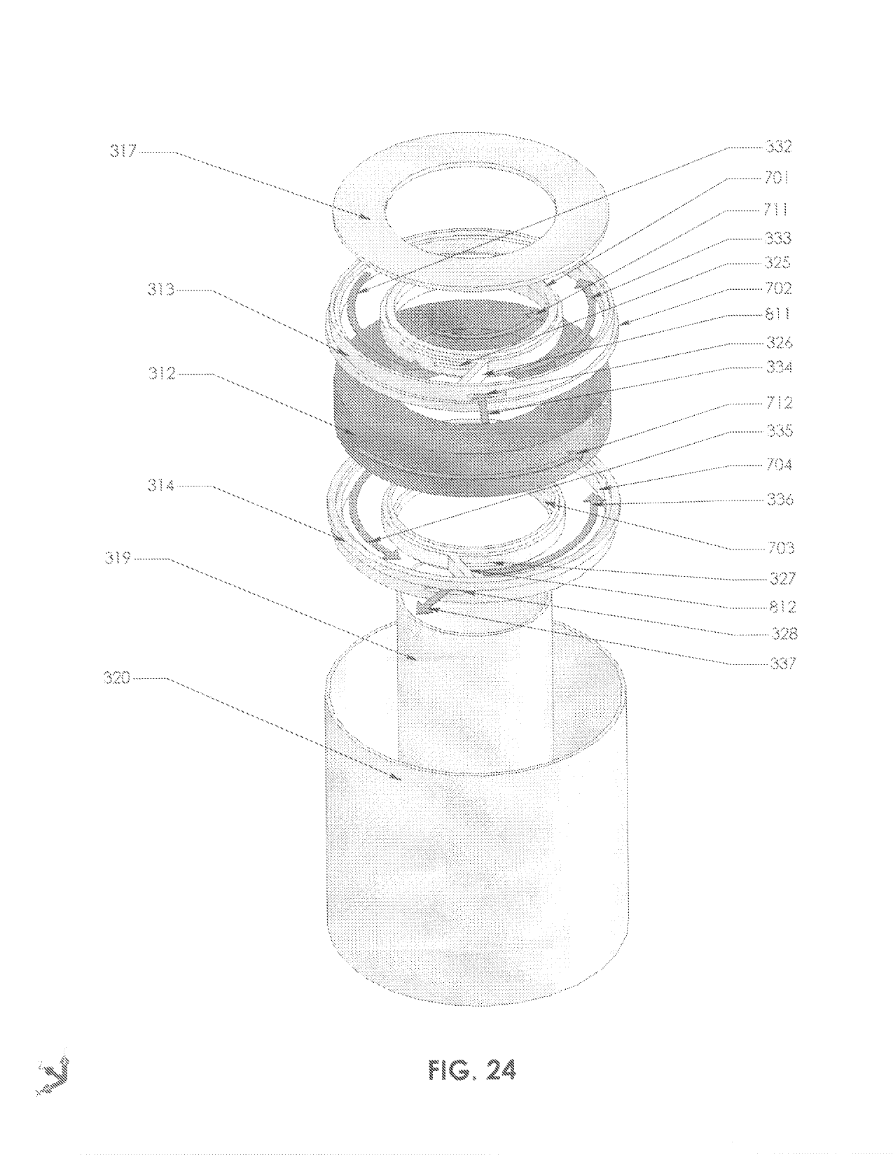

Referring to FIG. 24, an exploded view of a preferred embodiment of a housing with partitions to allow fluid passing in series through the upper and lower annular surfaces of each ring magnet. Arrow 334 showing fluid flows through inlet 326 into first annular channel 801 and continues to flow in anticlockwise direction as shown by arrows 333 and 332 until blocked by projection 811. Fluid continues to flow, bypassing the tenth annular channel 810. Fluid continues to flow into the third annular channel 803 through inlet 327 in anticlockwise direction as shown by arrows 336 and 335 until blocked by projection 812 and then exits through outlet 328 of the third annular channel 803. The above detailed description of how fluid flows along the annular surfaces of the ring magnet 312 also applies to the ring magnets 311 and 310.

Referring to FIG. 23 again, fluid will bypass the third annular channel 803 and the seventh annular channel 807 if the projection 812 and projection 814 are removed. Therefore, fluid flows through only the north poles of the ring magnets. Furthermore, if the projection 811 is also removed, fluid will flow through only the annular channel with north poles on both side of the annular channel. Similarly, fluid will bypass the first annular channel 801 and the fifth annular channel 805 if the projection 811 and projection 813 are removed. Therefore, fluid flows through only the south poles of the ring magnets. Furthermore, if the projection 814 is also removed, fluid will flow through only the annular channel with south poles on both side of the annular channel.

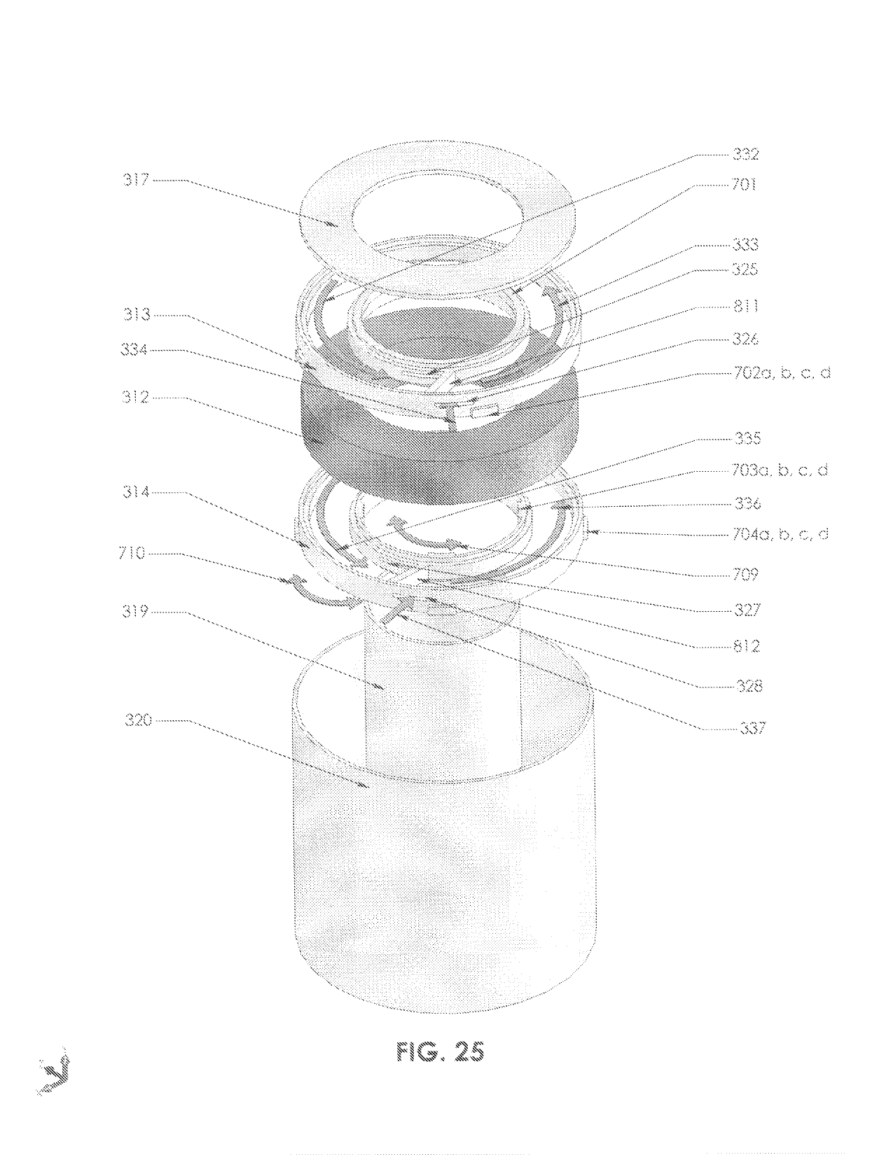

Referring to FIG. 25, an exploded view of a preferred embodiment of a housing with partitions to allow fluid passing in parallel through the upper and lower annular surfaces of all ring magnets. Annular projections 701, 702, 703, 704, 705, 706, 707 and 708 are tight fitted with either inner wall 319 or outer wall 320 for sealing. The annular projection 701 is kept unchanged and also the annular projection 708 is moved from the upper portion of the partition 316 to the lower portion of partition 316. Each of the annular projections 702, 703, 704, 705 and 706 is replaced with four projection points as shown in FIG. 25. The stack of ring magnets is still held in place as before. For the third annular channel 803, outlet 328 is moved from the left of partition 812 to the right of partition 812 and the inlet 327 is moved from the right of partition 812 to the left of the partition 812. Same for the fifth annular channel 805: outlet 332 is moved from the left of partition 814 to the right of partition 814 and the inlet 331 is moved from the right of partition 814 to the left of the partition 814. Annular channels 802, 804 and 806 are connected as internal annular channel 709. Similarly, annular channels 808, 809 and 810 are also connected as external annular channel 710. Fluid flow enters the external annular channel 710 into the first annual channel 801 and the third annular channel 803. Arrows 334 and 337 showing fluid flows simultaneously into the first annular channel 801 and the third annular channel 803 through inlet 326 and inlet 328, respectively, and flows in an anticlockwise direction as shown by arrows 333, 332, 335 and 336, respectively. Eventually, fluid exits through outlet 325 and outlet 327 simultaneously into the internal annual channel 709. The above detailed description of how fluid flows along the annular surfaces of the ring magnet 312 also applies to the ring magnets 311 and 310.

Referring to FIG. 23 again, fluid will bypass the third annular channel 803 and the seventh annular channel 807 if the inlet 328 and inlet 332 are removed. Therefore, fluid flows through only the north poles of the ring magnets. Furthermore, if the inlet 326 is also removed, fluid will flows through only the annular channel with north poles on both side of the annular channel. Similarly, fluid will bypass the first annular channel 801 and the fifth annular channel 805 if the inlet 326 and inlet 330 are removed. Therefore, fluid flows through only the south poles of the ring magnets. Furthermore, if the inlet 332 is removed, fluid will flow through only the annular channel with south poles on both side of the annular channel.

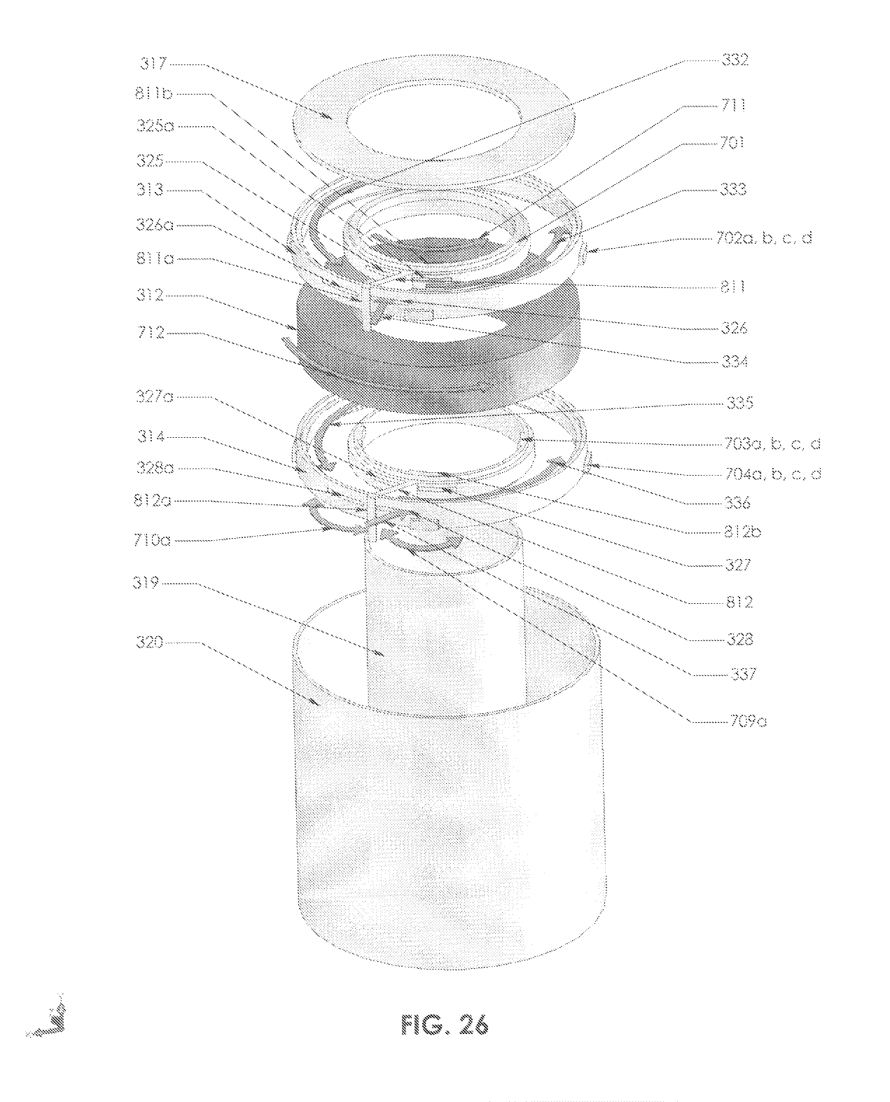

Referring to FIG. 26, an exploded view of a preferred embodiment of a housing with partitions to allow fluid passing in parallel through the upper, outer, lower and inner annular surfaces of all ring magnets. Annular projections 701, 702, 703, 704, 705, 706, 707 and 708 are tight fitted with either inner wall 319 or outer wall 320 for sealing. The annular projections 701 and 707 are kept unchanged and also the annular projection 708 is moved from the upper portion of the partition 316 to the lower portion of the partition 316. Each of the annular projections 702, 703, 704, 705 and 706 is replaced by four projection points as shown in FIG. 26. The stack of ring magnets is still hold in place as before. For the third annular channel 803, outlet 328a is added to the right side of partition 812 and the inlet 327a is add to the left side of the partition 812. Same for the fifth annular channel 805: outlet 332a is added to the right side of partition 814 and the inlet 331a is added to the left side of the partition 814. Right side of the annular channels 802, 804 and 806 are connected as inlet annular channel 710b. Similarly, left side of the annular channels 802, 804 and 806 are also connected as outlet annular channel 710a. Projections 811a and 811b are added to the partition 313 as shown in FIG. 26. Same as above, partition 812a, 812b are added to the partition 314 as shown in FIG. 26. Fluid flows into the housing 800 through the inlet annular channel 710b. Arrows 334 and 337 showing fluid flows simultaneously into the first annular channel 801 and the third annular channel 803 through inlet 326 and inlet 328, respectively, and flows in an anticlockwise direction as shown by arrows 333, 332, 335 and 336 respectively. At the same time, fluid also flows along the outer and inner annular surfaces of the ring magnet 312 in an anticlockwise direction as shown by arrows 712 and 711, respectively, until blocked by the partition 812a, 811a, 812b and 811b. Eventually, fluid flows along the four annular surfaces of the ring magnet 312 exits the housing 800 through the outlet channel 710a simultaneously. The above detailed description of how fluid flows along the annular surfaces of the ring magnet 312 also applies to the ring magnets 311 and 310.

It is understood that new configuration of stack of ring magnets can be created by adding FIGS. 19, 24, 25 and 26 in any combination.

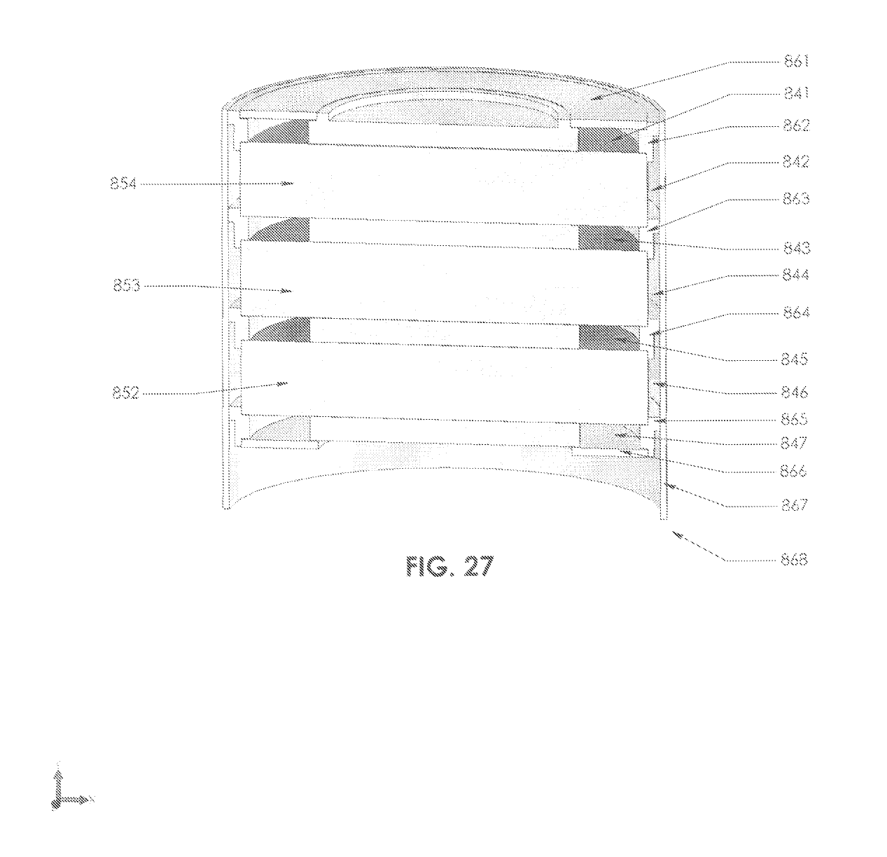

Referring to FIG. 27, a cross-sectional view of a stack of disc magnets with partitions in between and a housing to allow fluid passing in series through the upper and lower annular surfaces of each disc magnet. The stack of disc magnets is stationary. In order to maximize the effectiveness, fluid flow is touching all surfaces of all ring magnets. There are seven annual flow channels within the housing 868:
First annular flow channel 841, which allows fluid flows along the upper annular surface of disc magnet 854, is formed by partition 861, upper annular surface of disc magnet 854 and partition 862 with tight fitted for sealing without any O-ring;
Second annular flow channel 842, which allows fluid flows along the outer annular surface of disc magnet 854, is formed by partition 862, outer annular surface of disc magnet 854 partition 863 and outer wall 867 with tight fitted for sealing without any O-ring;
Third annular flow channel 843, which allows fluid flows along both the lower annular surface of disc magnet 854, and the upper annular surface of disc magnet 853, is formed by partition 863, lower annular surface of disc magnet 854 and upper annular surface of disc magnet 853 with tight fitted for sealing without any O-ring;
Fourth annular flow channel 854, which allows fluid flows along the outer annular surface of disc magnet 853, is formed by partition 863, outer annular surface of disc magnet 853, partition 864 and outer wall 867 with tight fitted for sealing without any O-ring;
Fifth annular flow channel 845, which allows fluid flows along the lower annular surface of disc magnet 853 and the upper annular surface of disc magnet 852, is formed by partition 864, lower annular surface of disc magnet 853 and upper annular surface of disc magnet 852 with tight fitted for sealing without any O-ring;
Sixth annular flow channel 846, which allows fluid flows along the outer annular surface of disc magnet 852, is formed by partition 864, outer annular surface of disc magnet 852, partition 865 and outer wall 867 with tight fitted for sealing without any O-ring; and
Seventh annular flow channel 847, which allows fluid flows along the lower annular surface of disc magnet 852, is formed by partition 865, lower annular surface of disc magnet 852 and partition 866 with tight fitted for sealing without any O-ring.

Although FIG. 27 shows a configuration of a stack of three disc magnets, the configuration can be easily modified to either one disc magnet or a stack of four or more disc magnets.

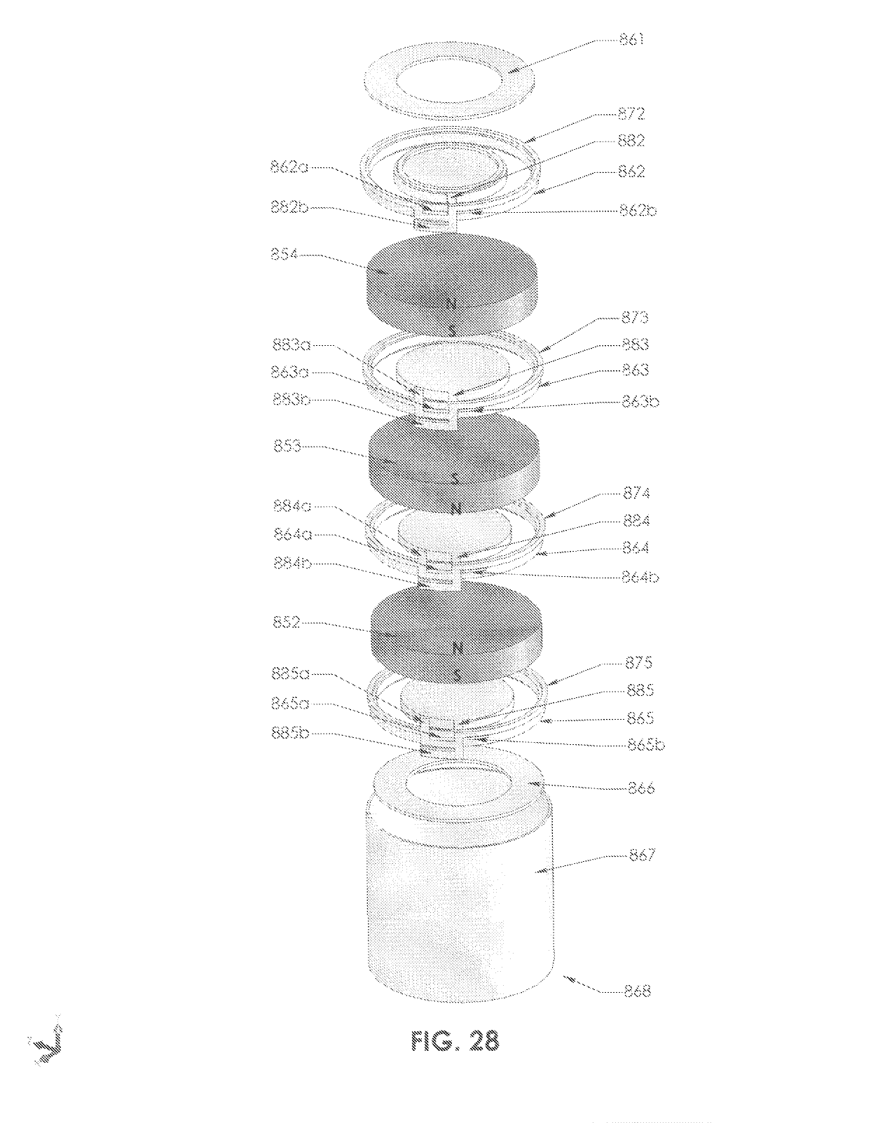

Referring to FIG. 28, an exploded view of a preferred embodiment of a stack of disc magnets with partitions in between and a separate housing to allow fluid passing in series through the upper and lower annular surfaces of each disc magnet. Fluid enters the first annular channel 841 through inlet 862a flows in clockwise direction until blocked by projection 882 and then exits through outlet 862b. Fluid continues to flow, bypassing the second annular channel 842. Fluid continues to flow into the third annular channel 843 through inlet 863a in clockwise direction until blocked by projection 883 and then exits through outlet 863b of third annular channel 803. Fluid continues to flow, bypassing the fourth annular channel 844. Fluid continues to flow into the fifth annular channel 845 through inlet 864a in clockwise direction until blocked by projection 884 and then exits through outlet 864b of fifth annular channel 845. Fluid continues to flow, bypassing the sixth annular channel 846. Fluid continues to flow into the seventh annular channel 847 through inlet 865a in clockwise direction until blocked by projection 885 and then exits through outlet 865b of the seventh annular channel 847.

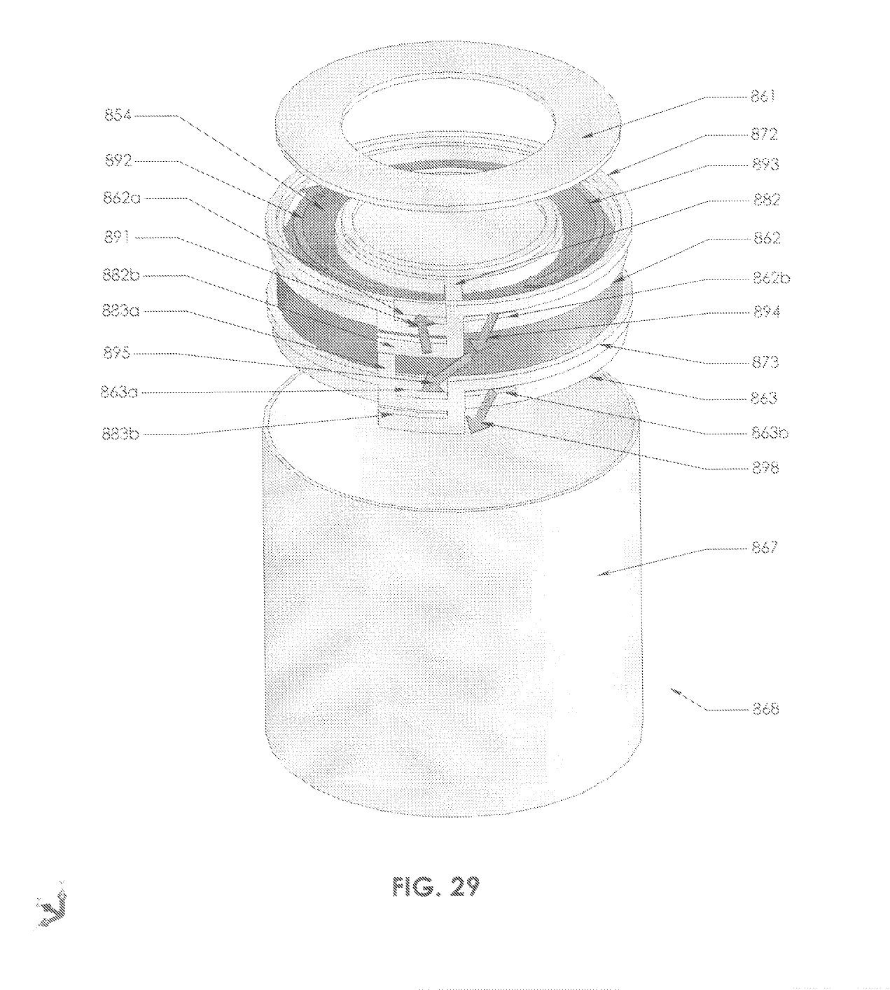

Referring to FIG. 29, an exploded view of a preferred embodiment of a separate housing to allow fluid passing in series through the upper and lower annular surfaces of each disc magnet without showing the stack of disc magnets with an insert provided therebetween. Arrow 891 showing fluid flows through inlet 862a into first annular channel 841 and continues to flow in clockwise direction as shown by arrows 892 and 893 until blocked by projection 882. Fluid continues to flow, bypassing the second annular channel 842 as shown by arrows 894 and 895. Fluid continues to flow into the third annular channel 843 through inlet 863a in clockwise direction until blocked by projection 883 and then exits through outlet 863b of the third annular channel 843 as shown by arrow 898. The above detailed description of how fluid flows along the annular surfaces of the disc magnet 854 also applies to the disc magnets 853 and 852.

Referring to FIG. 28 again, fluid will bypass the third annular channel 843 and the seventh annular channel 847 if the projection 883 and projection 885 are removed. Therefore, fluid flows through only the north poles of the ring magnets. Furthermore, if the projection 882 is also removed, fluid will flows through only the annular channel with north poles on both side of the annular channel. Similarly, fluid will bypass the first annular channel 841 and the fifth annular channel 845 if the projection 882 and projection 884 are removed. Therefore, fluid flows through only the south poles of the ring magnets. Furthermore, if the projection 885 is also removed, fluid will flow through only the annular channel with south poles on both side of the annular channel.

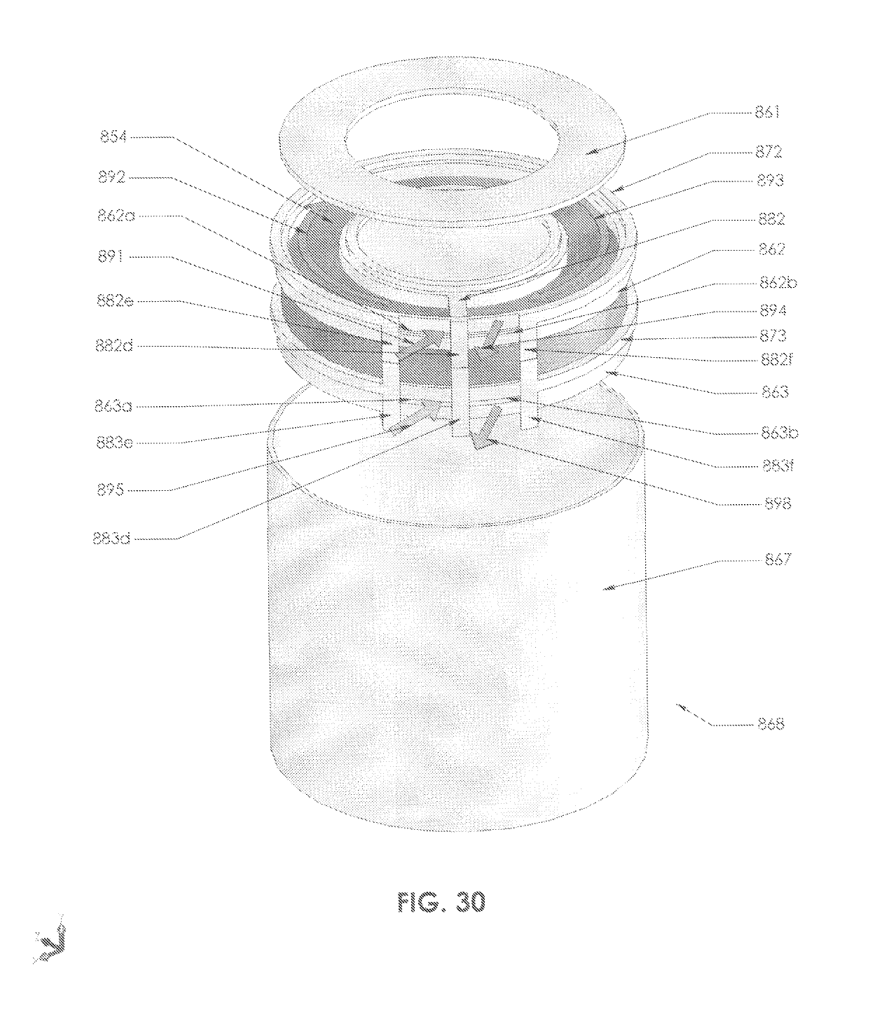

Referring to FIG. 30, an exploded view of a preferred embodiment of a separate housing to allow fluid passing in parallel through the upper and lower annular surfaces of all disc magnets without showing the stack of disc magnets with an insert provided therebetween. Each of the projections 882a-b, 883a-b, 884a-b and 885a-b is replaced with three projections as shown in FIG. 30. Fluid flows in through the space in between partition 882e and 882d. Arrows 891 and 895 showing fluid flow through inlet 862a into first annular channel 841 and inlet 863a into third annular channel 843 simultaneously. Fluid continues to flow in clockwise direction until blocked by projections 882 and 883 and then exits through outlet 862b and 863b. Eventually fluid flows out through the space in between partitions 882f and 882d. The above detailed description of how fluid flows along the annular surfaces of the disc magnet 854 also applies to the disc magnets 853 and 852.

Referring to FIG. 28 again, fluid will bypass the third annular channel 843 and the seventh annular channel 847 if the inlet 863a and inlet 865a are removed. Therefore, fluid flows through only the north poles of the ring magnets. Furthermore, if the inlet 862a is also removed, fluid will flow through only the annular channel with north poles on both side of the annular channel. Similarly, fluid will bypass the first annular channel 841 and the fifth annular channel 845 if the inlet 862a and inlet 864a are removed. Therefore, fluid flows through only the south poles of the ring magnets. Furthermore, if the inlet 865a is also removed, fluid will flow through only the annular channel with south poles on both side of the annular channel.

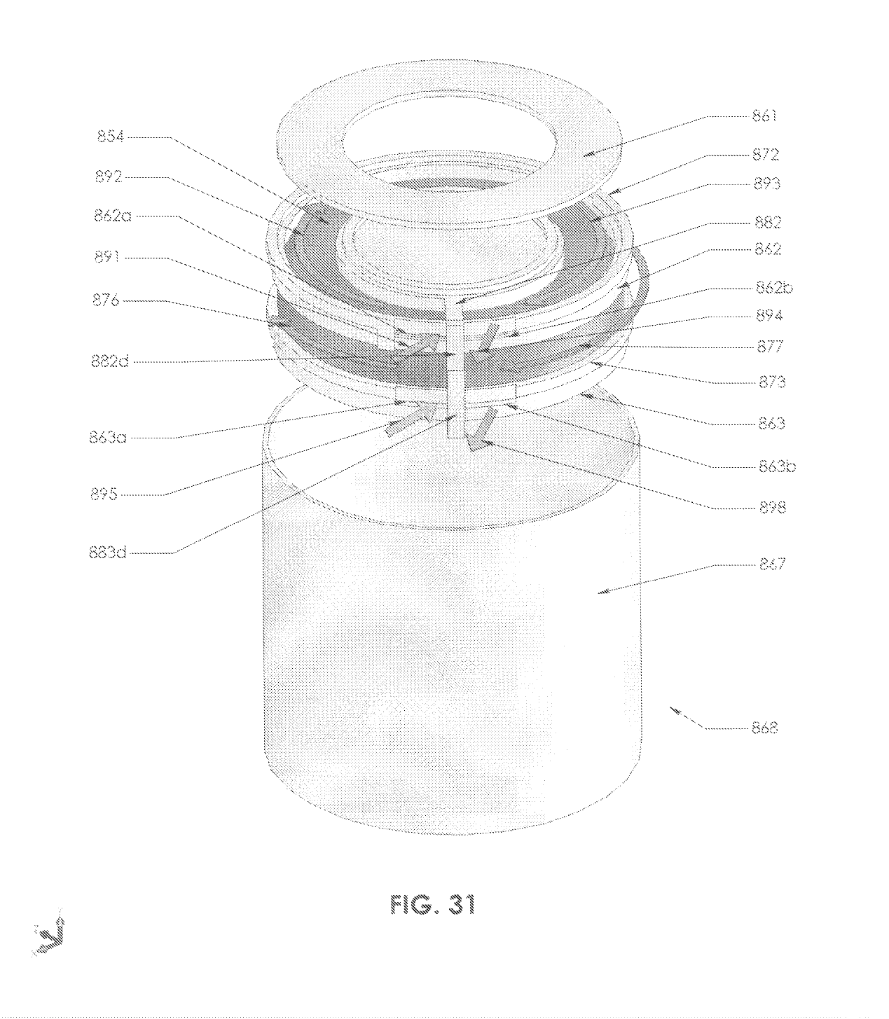

Referring to FIG. 31, an exploded view of a preferred embodiment of a separate housing to allow fluid passing in parallel through the upper, outer, and lower annular surfaces of all disc magnets without showing the stack of disc magnets with an insert provided therebetween. Each of the projections 882a-b, 883a-b, 884a-b and 885a-b is replaced with projections 882d, 883d, 884d and 885d respectively, as shown in FIG. 31. Fluid flows in through the space of the left side of projection 882d. Arrows 891, 876 and 895 showing fluid flows through inlet 862a into first annular channel 841, left side of second channel 842 and inlet 863a into third annular channel 843 simultaneously. Fluid continues to flow in clockwise direction as shown by arrows 892, 893 and 877 until blocked by projections 882, 882d and 883 and then exits through outlet 862b as shown by arrow 894, right side of second annular channel 842 and 863b as shown by arrow 898. Eventually, fluid flows out through the space of the right side of projection 882d. The above detailed description of how fluid flows along the annular surfaces of the disc magnet 854 also applies to the disc magnets 853 and 852.

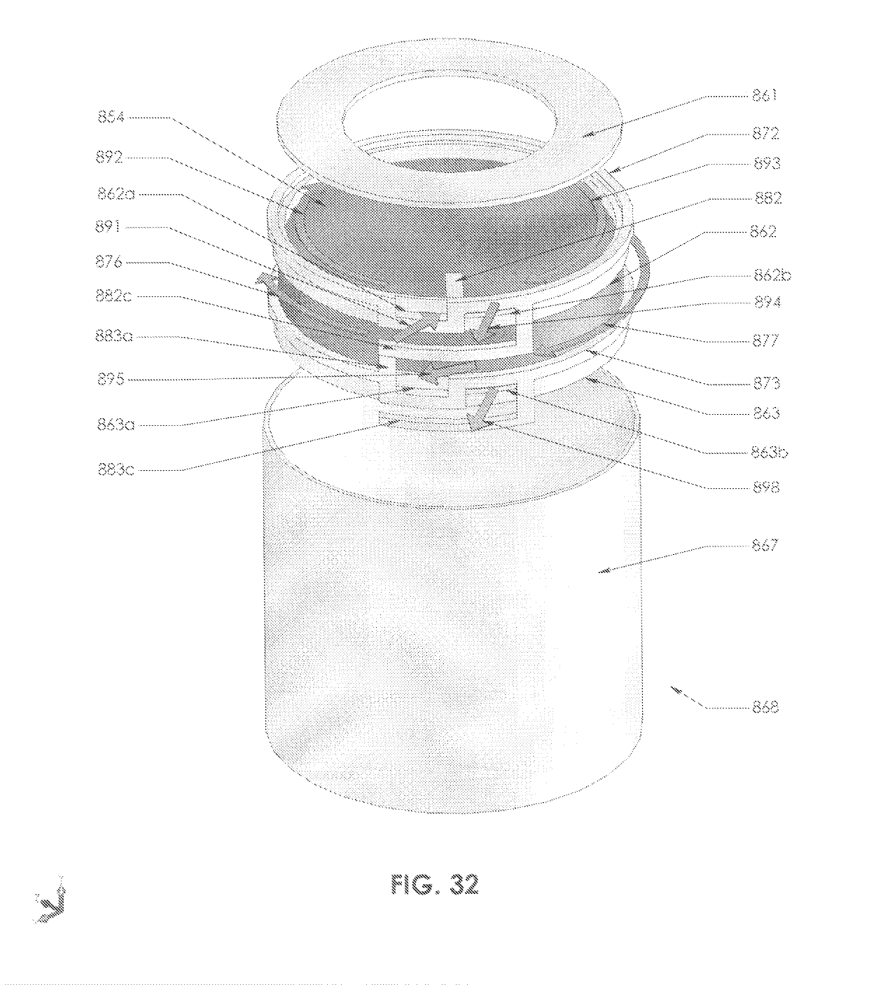

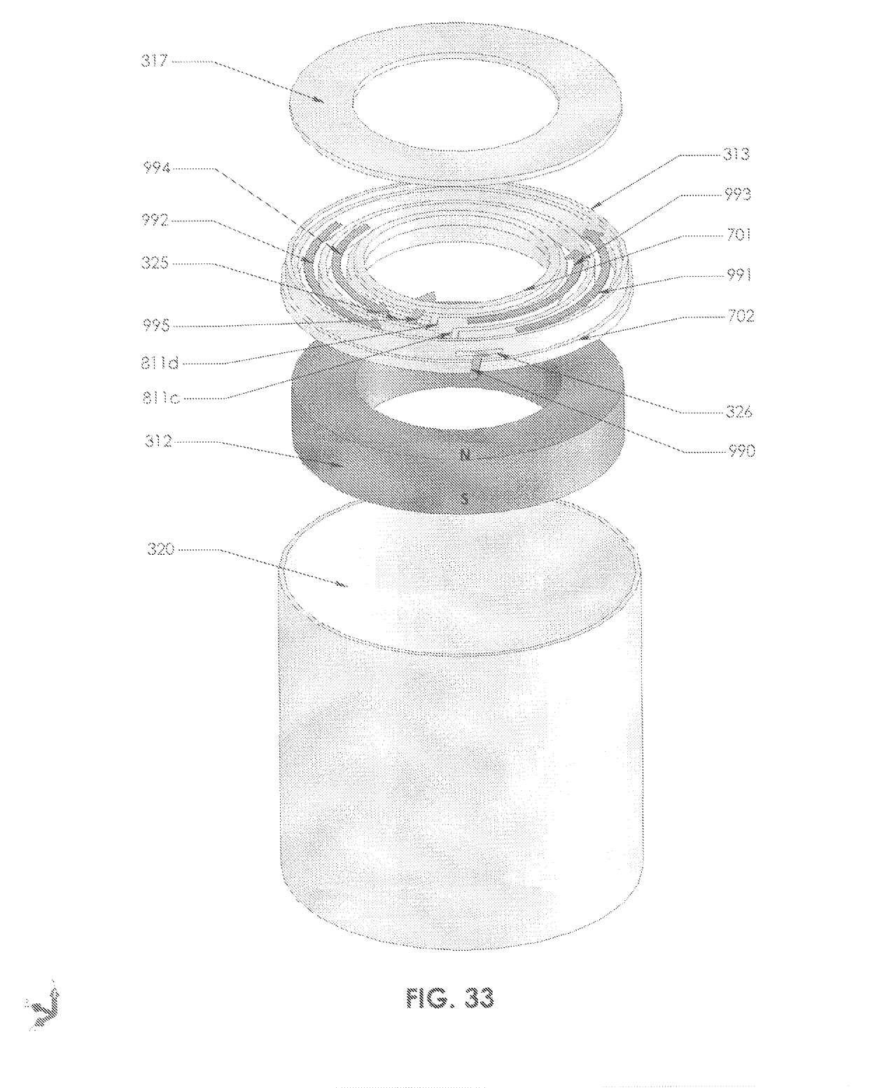

Referring to FIG. 32, an exploded view of a preferred embodiment of a separate housing to allow fluid passing in series through the upper, outer, and lower annular surfaces of each disc magnets without showing the stack of disc magnets with an insert provided therebetween. Arrow 891 showing fluid flow through inlet 862a into first annular channel 841 and continues to flow in clockwise direction as shown by arrows 892 and 893 until blocked by projection 882. Fluid continues to flow through the second annular channel 842 in clockwise direction as shown by arrows 894, 876 and 877 until blocked by projections 882c and 883a. Fluid continues to flow into the third annular channel 843 through inlet 863a in clockwise direction as shown by arrow 895 until blocked by projection 883 and then exits through outlet 863b of the third annular channel 843 as shown by arrow 898. The above detailed description of how fluid flows along the annular surfaces of the disc magnet 854 also applies to the disc magnets 853 and 852.

It is understood that new configuration of stack of ring magnets can be created by adding FIGS. 29, 30, 31 and 32 in any combination.

Referring to FIG. 33, an exploded view of a preferred embodiment of a partition on top of a ring magnet with fluid flows through two annular passes along the upper annular surface of that ring magnet. Basically, it is the same as what have been described in FIG. 24 but fluid flows through two annular passes along the upper annular surface of ring magnet 312 instead of only one annular pass as shown in FIG. 24. Fluid flows into inlet 326 as shown by arrow 990. Then fluid continues to flow through two annular passes as shown by arrows 991, 992, 993, 994 and exits through outlet 325 as shown by arrow 995.

Although FIG. 33 shows a preferred embodiment of a partition on top of a ring magnet with fluid flows through two annular passes along the upper annular surface of that ring magnet, the configuration can be easily modified to either fluid flows through only one, two or multiply annular passes. With modification, a ring-shaped electromagnet or disc magnet can replace the ring magnet in accordance with the configuration disclosed in the present invention and the result is the same as herein disclosed.

Thus it can be appreciated that the above described embodiments are illustrative of just a few of the numerous variations of arrangements of the disclosed elements used to carry out the disclosed invention. Moreover, while the invention has been particularly shown, described and illustrated in detail with reference to preferred embodiments and modifications thereof, it should be understood that the foregoing and other modifications are exemplary only, and that equivalent changes in form and detail may be made without departing from the true spirit and scope of the invention as claimed, except as precluded by the prior art.

What is claimed is:

1. A fluid magnetic treatment unit comprising:
a housing having an outer wall, a top and a bottom which define a chamber within said outer wall; said housing having a central longitudinal axis and a pair of opposite ends spaced along said axis, said housing being formed with a fluid inlet at said one end and a fluid outlet at said same end or other end to allow a fluid to flow through said chamber;
at least one annular magnet disposed in said chamber, said annular magnet extending perpendicularly across said chamber relative to said axis;
a top and a bottom partitions being disposed on above and below said annular magnet for allowing said fluid to flow annularly along at least one annular surface of said annular magnet.

2. The unit of claim 1, wherein said annular magnet is stationary.

3. The unit of claim 1, wherein said annular magnet is rotatably driven to spin directly or indirectly by a rotational means.

4. The unit of claim 3, wherein said spinning direction is opposite to the direction of said flow of fluid.

5. The unit of claim 1, comprising at least a pair of annular magnets.

6. The unit of claim 5, wherein said pair of annular magnets are positioned such that the same polarities of the adjacent annular magnets are facing each other.

7. The unit of claim 6, wherein said fluid flows annularly in parallel or in series or in any combination of in parallel and in series along both poles of said annular magnets.

8. The unit of claim 6, wherein said fluid flows annularly in parallel or in series or in any combination of in parallel and in series along same poles of said annular magnets.

9. The unit of claim 6, wherein said fluid flows annularly in parallel or in series or in any combination of in parallel and in series along annular surfaces of said annular magnets.

10. The unit of claim 5, wherein said pair of annular magnets are positioned such that the opposite polarities of the adjacent annular magnets are facing each other.

11. The unit of claim 10, wherein said fluid flows annularly in parallel or in series or in any combination of in parallel and in series along both poles of said annular magnets.

12. The unit of claim 10, wherein said fluid flows annularly in parallel or in series or in any combination of in parallel and in series along annular surfaces of said annular magnets.

13. The unit of claim 5, wherein said annular magnets are ring magnets, disc magnets or ring-shaped electromagnets.

14. A fluid magnetic treatment unit comprising:
a housing having an outer wall, a top and a bottom which define a chamber within said outer wall; said housing having a central longitudinal axis and a pair of opposite ends spaced along said axis, said housing being formed with a fluid inlet at said one end and a fluid outlet at said same end or other end to allow a fluid to flow through said chamber;
at least one annular magnet disposed in said chamber, said annular magnet extending perpendicularly across said chamber relative to said axis; said annular magnet having first set of covers made from magnetic material on the poles of the said magnet and second set of covers made from non-magnetic material on the other annular surfaces of the said magnet;
a top and a bottom partitions being disposed on above and below said annular magnet for allowing said fluid to flow annularly along at least one annular surface of said annular magnet.

15. The unit of claim 14, wherein said annular magnet is stationary.

16. The unit of claim 14, wherein said annular magnet is rotatably driven to spin directly or indirectly by a rotational means.

17. The unit of claim 16, wherein said spinning direction is opposite to the direction of said flow of fluid.

18. The unit of claim 14, comprising at least a pair of annular magnets.

19. The unit of claim 18, wherein said pair of annular magnets are positioned such that the same polarities of the adjacent annular magnets are facing each other.

20. The unit of claim 19, wherein said fluid flows annularly in parallel or in series or in any combination of in parallel and in series along both poles of said annular magnets.

21. The units of claim 19, wherein said fluid flows annularly in parallel or in series or in any combination of in parallel and in series along same poles of said annular magnets.

22. The unit of claim 19, wherein said fluid flows annularly in parallel or in series or in any combination of in parallel and in series along annular surfaces of said annular magnets.

23. The unit of claim 18, wherein said pair of annular magnets are positioned such that the opposite polarities of the adjacent annular magnets are facing each other.

24. The unit of claim 23, wherein said fluid flows annularly in parallel or in series or in any combination of in parallel and in series along both poles of said annular magnets.

25. The unit of claim 23, wherein said fluid flows annularly in parallel or in series or in any combination of in parallel and in series along annular surfaces of said annular magnets.

26. The unit of claim 18, wherein said annular magnets are ring magnets, disc magnets or ring-shaped electromagnets.

27. The unit of claim 14, wherein said magnetic material for said first set of covers is ferrite and said non-magnetic material for said second set of covers is plastic.

28. A method for magnetically treating fluid, said method comprising the steps of directing a fluid flow perpendicular to the line of magnetic force generated by an annular magnet mounted in a fluid treatment unit as claimed in claim 1.

29. The method of claim 28, further comprising the step of directly or indirectly causing said annular magnet to be rotatably driven to spin by a rotational means.

30. The method of claim 29, wherein said spinning direction is opposite to the direction of said flow of fluid.

31. The method of claim 28, wherein said annular magnets are ring magnets, disc magnets or ring-shaped electromagnets.
